(19) United States
(12) Patent Application Publication
(10) Pub. No.: US 2015/0332258 A1
(43) Pub. Date: Nov. 19, 2015

(54) Identity Verification via Short-Range Wireless Communications

(71) Applicant: QUALCOMM Incorporated, San Diego, CA (US)

(72) Inventors: Mohammad Kurabi, San Diego, CA (US); Shammi Khattar, San Diego, CA (US); Charles Stewart Wurster, San Diego, CA (US)

(21) Appl. No.: 14/493,459

(22) Filed: Sep. 23, 2014

Related U.S. Application Data
(60) Provisional application No. 62/000,351, filed on May 19, 2014.

(51) Int. Cl. G06Q 20/38; G06Q 20/32; G06Q 20/40

(52) U.S. Cl. CPC G06Q 20/382; G06Q 20/401; G06Q 20/327

(57) ABSTRACT

Embodiment methods, devices, non-transitory processor-readable storage media, and systems for conducting transactions based on proximity without sending secure information via short-range wireless signaling, comprising broadcasting, by a point-of-sale device, a short-range wireless message requesting a peripheral response, broadcasting, by a client device, a short-range wireless message indicating that the client device is available as a peripheral, receiving, at the point-of-sale device via an established short-range wireless connection, identifying data of the client device, transmitting, by the point-of-sale device to a server, a message including the received identifying data of the client device, transmitting, by the server to the point-of-sale device, an encrypted nonce, transmitting, by the point-of-sale device to the client device via the established connection, the encrypted nonce, decrypting, by the client device, the encrypted nonce, determining whether the decrypted nonce matches the unencrypted nonce, and conducting a transaction in response to the decrypted nonce matching the unencrypted nonce.

### RELATED APPLICATIONS

The present application claims the benefit of priority to U.S. Provisional Application No. 62/000,351, entitled “Identity Verification via Short-Range Wireless Communications” filed May 19, 2014, the entire contents of which are hereby incorporated by reference.

### BACKGROUND

Existing mobile payment solutions require users to interact with their mobile devices (e.g., smartphones) in order to pay for items. For example, users may be required to use their mobile devices to scan a quick response (QR) code, to tap a near-field communications (NFC) tag, or to present their mobile devices displaying a QR code for scanning by store devices. Additionally, mobile devices may be required to have Internet connectivity at the time of transaction (e.g., check-out) in order to process the payment or to exchange sensitive information to a point-of-sale (POS) device for processing. Such a connectivity requirement may be a drawback for users, as connectivity and quality of service (QoS) may not be guaranteed due to various factors, such as signal strength or coverage issues. Further, any transmission of secure information to point-of-sale devices may include inherent security risks. Other conventional techniques may utilize mobile devices with “hands-free” procedures and/or hub devices that utilize beacon messaging with a Wi-Fi backhaul.

### SUMMARY

Various embodiments provide methods, devices, systems, and non-transitory process-readable storage media for a client device to conduct transactions based on proximity to a point-of-sale device without sending secure information via short-range wireless signaling. An embodiment method performed by a processor of the client device may include transmitting, to a server via a wide area network connection, a first message including a public key of an encryption key pair, wherein the encryption key pair includes a private key stored on the client device, receiving, via short-range wireless signals, a second message broadcast from the point-of-sale device that requests a peripheral response from the client device, broadcasting, via the short-range wireless signals, a third message indicating that the client device is available as a peripheral in response to receiving the second message, establishing a short-range wireless connection with the point-of-sale device in response to the point-of-sale device receiving the third message, transmitting, via the established short-range wireless connection, identifying data to the point-of-sale device, receiving, via the established short-range wireless connection, an encrypted nonce from the point-of-sale device, decrypting the encrypted nonce using the private key, and transmitting, to the point-of-sale device via the established short-range wireless connection, the decrypted nonce.

In some embodiments, the second message broadcast by the point-of-sale device via the short-range wireless signals may include a secure identifier of the point-of-sale device, and the method may further include transmitting, to the server via the wide area network connection, a sighting message including the secure identifier of the point-of-sale device in response to receiving the second message, and receiving, from the server via the wide area network connection, a fourth message indicating whether the point-of-sale device can be trusted by the client device, wherein broadcasting, via the short-range wireless signals, the third message indicating that the client device is available as the peripheral in response to receiving the second message may include broadcasting, via the short-range wireless signals, the third message indicating that the client device is available as the peripheral in response to receiving the second message and in response to the fourth message indicating that the point-of-sale device can be trusted.

In some embodiments, the short-range wireless signals and the established short-range wireless connection may utilize a Bluetooth communication protocol. In some embodiments, the wide area network connection may utilize Internet communications. In some embodiments, the client device may be a mobile device and the transactions may be associated with a retailer.

An embodiment method performed by a processor of a point-of-sale device for conducting transactions based on proximity to a client device without sending secure information via short-range wireless signaling may include operations for broadcasting, via short-range wireless signals, a first message requesting a peripheral response, receiving, via the short-range wireless signals, a second message indicating that the client device is available as a peripheral in response to receiving the first message, establishing a short-range wireless connection with the client device in response to the point-of-sale device receiving the second message, receiving, via the established short-range wireless connection, identifying data of the client device, transmitting, to a server via a wide area network connection, a session start request including the received identifying data of the client device, receiving, via the wide area network connection from the server, an encrypted nonce generated by the server using an unencrypted nonce and a public key stored in a user profile associated with the received identifying data of the client device in response to transmitting the session start request, transmitting, to the client device via the established short-range wireless connection, the encrypted nonce, receiving, via the established short-range wireless connection, a decrypted nonce based on the encrypted nonce, and transmitting, to the server via the wide area network connection, information for conducting a transaction related to the client device in response to the client device being authenticated based on the received decrypted nonce.

In some embodiments, the method may further include receiving, via the wide area network connection from the server, the unencrypted nonce with the encrypted nonce in response to transmitting the session start request, and determining whether the received decrypted nonce matches the received unencrypted nonce, and wherein transmitting, to the server via the wide area network connection, the information for conducting the transaction related to the client device in response to the client device being authenticated based on the received decrypted nonce may include transmitting, to the server via the wide area network connection, the information for conducting the transaction related to the client device in response to determining the received decrypted nonce matches the received unencrypted nonce.

In some embodiments, the method may further include transmitting, via the wide area network connection to the server, a third message including the decrypted nonce, and receiving, via the wide area network connection from the server, a fourth message indicating whether the client device is authenticated based on the decrypted nonce. In such embodiments transmitting, to the server via the wide area network connection, the information for conducting the transaction related to the client device in response to the client device being authenticated based on the received decrypted nonce may include transmitting, to the server via the wide area network connection, the information for conducting the transaction related to the client device in response to the received fourth message indicating the client device is authenticated based on the decrypted nonce matching the unencrypted nonce stored on the server. In some embodiments, the method may further include receiving, via the wide area network connection from the server, a transaction result indicating whether the transaction was successful.

In some embodiments, the method may further include displaying the transaction result received from the server. In some embodiments, receiving, via the wide area network connection from the server, the encrypted nonce generated by the server using the unencrypted nonce and the public key stored in the user profile associated with the received identifying data of the client device in response to transmitting the session start request may include receiving, from the server via the wide area network connection, the encrypted nonce, the unencrypted nonce, and user authentication data from the stored user profile in response to transmitting the session start request, and the method may further include displaying the received authentication data, and receiving an input indicating whether a user of the client device is authenticated based on the user authentication data.

In some embodiments, the user authentication data may include an image of the user of the client device. In some embodiments, the short-range wireless signals and the established short-range wireless connection may utilize a Bluetooth communication protocol. In some embodiments, the wide area network connection may utilize Internet communications. In some embodiments, the method may further include receiving, from the server via the wide area network connection, an additional authentication request. In such embodiments the additional authentication request may require a driver's license check by an operator of the point-of-sale device. In some embodiments, the transaction may be associated with a retailer, and the point-of-sale device is owned by the retailer.

An embodiment system may include a client device, a point of sale device, and a server, in which the client device may include a first short-range wireless transceiver, a first wide area network interface in communication with a wide area network via a first wide area network connection, and a first processor configured with processor-executable instructions for performing operations for transmitting, to the server via the first wide area network interface, a first message including a public key of an encryption key pair, in which the encryption key pair includes a private key stored on the client device, receiving, via the first short-range wireless transceiver, a second message broadcast from the point-of-sale device that requests a peripheral response, broadcasting, via the first short-range wireless transceiver, a third message indicating that the client device is available as a peripheral in response to receiving the second message, establishing, with the first short-range wireless transceiver, a short-range wireless connection with the point-of-sale device in response to broadcasting the third message, transmitting, to the point-of-sale device via the short-range wireless connection established with the first short-range wireless transceiver, identifying data of the client device, receiving, from the point-of-sale device via the short-range wireless connection established with the first short-range wireless transceiver, an encrypted nonce, decrypting the encrypted nonce using the private key, and transmitting, to the point-of-sale device via the short-range wireless connection established with the first short-range wireless transceiver, the decrypted nonce.

In an embodiment system, the point-of-sale device may include a second short-range wireless transceiver, a second wide area network interface in communication with the wide area network via a second wide area network connection, and a second processor configured with processor-executable instructions for performing operations for broadcasting, via the second short-range wireless transceiver, the second message requesting the peripheral response, receiving, via the second short-range wireless transceiver, the third message indicating that the client device is available as the peripheral in response to broadcasting the second message, establishing, with the second short-range wireless transceiver, the short-range wireless connection with the client device in response to the point-of-sale device receiving the third message, receiving, from the client device via the short-range wireless connection established with the second short-range wireless transceiver, the identifying data, transmitting, to the server via the second wide area network interface, a session start request including the received identifying data of the client device, receiving, from the server via the second wide area network connection, the encrypted nonce in response to transmitting the session start request, transmitting, to the client device via the short-range wireless connection established with the second short-range wireless transceiver, the encrypted nonce, receiving, from the client device via the short-range wireless connection established with the second short-range wireless transceiver, the decrypted nonce, and transmitting, to the server via the second wide area network interface, information for conducting a transaction related to the client device in response to the client device being authenticated based on the received decrypted nonce.

In an embodiment system, the server may include a third wide area network interface in communication with the wide area network via a third wide area network connection, and a third processor configured with processor-executable instructions for performing operations for receiving, from the client device via the third wide area network interface, the first message including the public key of the encryption key pair, storing the received public key in relation to a user profile associated with the client device, receiving, from the point-of-sale device via the third wide area network interface, the session start request including the received identifying data of the client device, generating the encrypted nonce by encrypting an unencrypted nonce with the public key stored in the user profile associated with the identifying data of the client device, transmitting, to the point-of-sale device via the third wide area network connection, the encrypted nonce in response to receiving the session start request, and receiving, from the point-of-sale device via the third wide area network interface, the information for conducting the transaction related to the client device in response to the client device being authenticated based on the decrypted nonce.

In some embodiments, the second message broadcast by the point-of-sale device via short-range wireless signals may include a secure identifier of the point-of-sale device, and the first processor of the client device may be configured with processor-executable instructions for performing operations that may further include transmitting to the server via the first wide area network interface a sighting message including the secure identifier of the point-of-sale device in response to receiving the second message, and receiving, from the server via the first wide area network interface, a fourth message indicating whether the point-of-sale device can be trusted by the client device. The first processor of the client device may be configured with processor-executable instructions such that broadcasting, via the first short-range wireless transceiver, the third message indicating that the client device may be available as the peripheral in response to receiving the second message may include broadcasting, via the first short-range wireless transceiver, the third message indicating that the client device may be available as the peripheral in response to receiving the second message and the fourth message indicating that the point-of-sale device can be trusted. The third processor of the server may be configured with processor-executable instructions for performing operations that may further include receiving, from the client device via the third wide area network interface, the sighting message including the secure identifier of the point-of-sale device, processing the secure identifier of the sighting message to determine whether the point-of-sale device can be trusted by the client device, and transmitting, to the client device via the third wide area network interface, the fourth message indicating whether the point-of-sale device can be trusted by the client device based on the processing.

In some embodiments, the second processor of the point-of-sale device may be configured with processor-executable instructions for performing operations that may further include receiving, from the server via the second wide area network interface, the unencrypted nonce with the encrypted nonce in response to transmitting the session start request, and determining whether the received decrypted nonce matches the received unencrypted nonce. The second processor of the point-of-sale device may be configured with processor-executable instructions for performing operations such that transmitting, to the server via the second wide area network interface, the information for conducting the transaction related to the client device in response to the client device being authenticated based on the received decrypted nonce may include transmitting, to the server via the second wide area network interface, the information for conducting the transaction related to the client device in response to determining the received decrypted nonce matches the received unencrypted nonce. The third processor of the server may be configured with processor-executable instructions for performing operations that may further include transmitting, to the point-of-sale device via the third wide area network connection, the unencrypted nonce in response to receiving the session start request.

In some embodiments, the second processor of the point-of-sale device may be configured with processor-executable instructions for performing operations that may further include transmitting, to the server via the second wide area network interface, a fourth message including the decrypted nonce, and receiving, from the server via the second wide area network interface, a fifth message indicating whether the client device may be authenticated based on the decrypted nonce. In such embodiments transmitting, to the server via the second wide area network interface, the information for conducting the transaction related to the client device in response to the client device being authenticated based on the received decrypted nonce may include transmitting, to the server via the second wide area network connection, the information for conducting the transaction related to the client device in response to the received fifth message indicating the client device may be authenticated based on the decrypted nonce matching the unencrypted nonce stored on the server. In such embodiments the third processor of the server may be configured with processor-executable instructions for performing operations that may further include receiving, from the point-of-sale device via the third wide area network interface, the fourth message including the decrypted nonce, determining whether the client device may be authenticated based on the decrypted nonce matching the unencrypted nonce stored on the server, and transmitting, to the point-of-sale device via the third wide area network interface, the fifth message indicating the client device may be authenticated based on the decrypted nonce in response to determining the decrypted nonce matches the unencrypted nonce stored on the server.

Further embodiments include a computing device configured with processor-executable instructions for performing operations of the methods described above. Further embodiments include a non-transitory processor-readable medium on which is stored processor-executable instructions configured to cause a computing device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system diagram illustrating network components of embodiment architectures suitable for use in various embodiments.

FIGS. 2A-2B are system process flow diagrams illustrating embodiment methods for a point-of-sale device to exchange short-range wireless communications with a nearby client mobile device and long-range communications with a remote server to exchange data for conducting transactions.

FIGS. 3A-3B are system process flow diagrams illustrating embodiment methods for a point-of-sale device to exchange short-range wireless communications with a nearby client mobile device and long-range communications with a remote server to exchange data for conducting transactions that are authenticated by additional data at the point-of-sale device.

FIG. 4 is system process flow diagram illustrating embodiment methods for a point-of-sale device to exchange short-range wireless communications with a nearby client mobile device and long-range communications with a remote server to exchange data for conducting transactions when the point-of-sale device is confirmed as a trusted device.

FIG. 5 is a call flow diagram of exemplary communications between a point-of-sale device, a client device, and a server in accordance with some embodiments.

FIG. 6 is a system process flow diagram illustrating embodiment methods for a point-of-sale device to exchange short-range wireless communications with a nearby client mobile device and long-range communications with a remote server to exchange data for conducting transactions that are authenticated at the server.

FIG. 7 is a component block diagram of a point-of-sale device suitable for use with various embodiments.

FIG. 8 is a component block diagram of a mobile device suitable for use in various embodiments.

FIG. 9 is a component block diagram of a server device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile device” is used herein to refer to any one or all of cellular telephones, smart-phones (e.g., iPhone®), web-pads, tablet computers, Internet enabled cellular telephones, Wi-Fi enabled electronic devices, personal data assistants (PDA's), laptop computers, personal computers, and similar electronic computing devices equipped with a short-range wireless transceiver (e.g., a Bluetooth® radio, a Peanut® radio, a Wi-Fi radio, etc.) and a wide area network interface or connection (e.g., an LTE, 3G or 4G wireless wide area network transceiver or a wired connection to the Internet). Reference to a particular type of computing device as being a mobile device is not intended to limit the scope of the claims unless a particular type of mobile device is recited in the claims.

The term “point-of-sale device” (or “POS device”) is used herein to refer to devices utilized in conducting transactions in sales or retail environments. For example, a point-of-sale device may be a cash register device configured to transmit sales transaction data (e.g., items purchase, costs, billing information, etc.) to remote sources via the Internet. In various embodiments, point-of-sale devices may be computing devices that include at least a processor, a network interface for communicating via a wide area network (e.g., a cellular network, the Internet, etc.), and a short-range wireless transceiver for communicating with proximate devices using various wireless signaling technologies or communication protocols (e.g., Bluetooth, Zigbee, RF, etc.).

The term “server” is used to refer to any computing device capable of functioning as a server, such as a master exchange server, web server, mail server, document server, and a personal or mobile computing device configured with software to execute server functions (e.g., a “light server”). Servers may utilize various network interfaces or connections (e.g., Ethernet, etc.) for communicating via wide area networks, such as the Internet. A server may be a dedicated computing device or a computing device including a server module (e.g., running an application which may cause the computing device to operate as a server). A server module (or server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein.

The terms “short-range wireless broadcast message” or “broadcast message” are used herein to refer to short-range wireless broadcast signals broadcast by devices, such as smartphones or point-of-sale devices equipped with short-range wireless transceivers (e.g., Bluetooth radios, etc.). In some embodiments, broadcast messages may include identification information (e.g., identifiers) associated with the transmitting devices and/or their users. Such identifiers may be periodically changed and encrypted, encoded, or otherwise obscured (e.g., rolling identifiers). In various embodiments, broadcast messages may be transmitted via a wireless communication protocol, such as Bluetooth® Low Energy, Wi-Fi, Wi-Fi Direct, Zigbee®, Peanut®, RF, and/or various other signaling technologies and/or protocols.

The various embodiments provide methods, devices, non-transitory processor-readable storage media, and systems for enabling identification of a user of a client device (e.g., a smartphone, a tablet, etc.) to easily conduct transactions (e.g., paying for goods in a store) based on proximity to a point-of-sale (POS) device (e.g., a cash register computing device, etc.) without sending secure information via short-range wireless signaling. In particular, the client mobile device (or client device) may be registered with a server via a wide area network (WAN) connection (e.g., Internet connection). Such a registration may include providing the server with authentication data of the client device (e.g., a device identifier, media access control (MAC) address, etc.) and/or of the user of the client device (e.g., username, address, photo image, writing sample, etc.). Further, the client device may generate a public key encryption pair, such as a private key stored for use with the client device and a public key for use by other devices (e.g., the server), and transmit the public key to the server during the registration. Once the registration is complete, the client device may no longer be required to communicate via WAN with the server (i.e., no backhaul is required for the client device), making the embodiment techniques resource economical for user devices.

The point-of-sale device may be configured to periodically and continually broadcast a short-range wireless message for receipt by proximate devices. For example, the broadcast messages may be standard non-pairing (or non-connectable) Bluetooth advertisement packets. The broadcast messages may include data, codes, or other information that may be processed by recipient devices (e.g., the client device) as instructions to transmit messages indicating whether they are capable of operating as a peripheral (e.g., a Bluetooth peripheral). The point-of-sale device may scan for short-range wireless signals responding to its broadcast messages.

In response to receiving such a short-range wireless broadcast message from the point-of-sale device, the client device may configure itself to be available for connections with the point-of-sale device, and may begin broadcasting its own messages, referred to herein as peripheral responses (or peripheral response messages), for a predefined period of time that indicate the client device is currently configured to operate as a peripheral (e.g., a Bluetooth peripheral). In this responsive manner, the client device may only transmit peripheral response messages when in proximity of a point-of-sale device, thus saving power and reducing exposure to other devices. Such peripheral response messages from the client device may also be standard non-pairing (or non-connectable) messages, such as non-connectable Bluetooth advertisement packets (e.g., standard Bluetooth 4.0 peripheral mode).

In response to receiving the client device's peripheral response messages via short-range wireless signals, the point-of-sale device may initiate a connection to the client device, such as a Bluetooth paired connection. With the established connection, the point-of-sale device may transmit a request (e.g., a read request or a read call) to the client device to retrieve the client device's identifying data, particularly a client identifier (or client ID). The point-of-sale device may utilize a WAN connection, such as via a Wi-Fi link or cellular network, to transmit a session start request to the server, including the client device's identifying data (client ID).

In response, the server may start a transaction session (e.g., a check-out session) for the client device, and further may perform a look-up using the client device's identifying data received from the point-of-sale device to find stored data (e.g., a user profile or registered account) associated with the identifying data. Using the public key stored in the found stored data related to the identifying data, the server may generate an encrypted nonce. For example, the server may perform a standard RSA Pretty Good Privacy (PGP) signing to make the encrypted nonce. The server may transmit the encrypted nonce and the unencrypted nonce back to the point-of-sale device. However, in some embodiments, the server may only transmit the encrypted nonce so that less secure information is not transmitted to the point-of-sale device via the Internet. In such embodiments, the server may subsequently receive information from the point-of-sale device to be matched to the unencrypted nonce stored only on the server.

Using the short-range wireless connection, the point-of-sale device may transmit the encrypted nonce to the client device, and in response the client device may perform a decryption operation on the encrypted nonce using its locally stored private key. The resulting decrypted nonce may be transmitted back to the point-of-sale device via the short-range wireless connection. In some embodiments, the point-of-sale device may compare the unencrypted nonce received from the server and the decrypted nonce received from the client device to determine whether the client device is verified (i.e., the same device that is registered with the server). In some embodiments, the point-of-sale device may not have access to the unencrypted nonce, and thus may transmit the decrypted nonce to the server for comparisons with the unencrypted nonce to determine whether there is a match (i.e., whether the identity of the client device is verified).

If the identity of the client device is verified, the point-of-sale device may transmit information related to a transaction, such as items, prices, and other data related to purchasing goods at a store, to the server for further operations. For example, the server may receive information to automatically charge a financial account linked to the client device's user's account stored at the server.

Embodiment techniques may be beneficial and improve the functioning of client mobile devices as they may not be required to have Internet connectivity, a running application (or app), and/or GPS capabilities at the time of a transaction (e.g., when processing a payment). In other words, the functioning of the client mobile devices may be improved by freeing the client mobile devices from the need to communicate via a WAN (i.e., no backhaul is required for the client device), thereby conserving power once registration of users with the server is complete. Further, as the transmission of sensitive information via short-range methods is limited, the embodiment techniques improve the functioning of client mobile devices by making such mobile device more secure and viable for use as payment or transaction facilitators. Further, transactions with the embodiment techniques may be passive to users, not requiring their interaction with mobile devices or other payment devices (e.g., fobs, scanners, smartcards, credit cards, etc.).

As an example of such a procedure, a user carrying a smartphone registered with the server may walk up to a point-of-sale device (e.g., a cash register) operated by a cashier of a grocery store. The smartphone and point-of-sale device may exchange short-range wireless communications without being prompted by either the user or the cashier. Similarly, the point-of-sale device may use its WAN connection to exchange data with the server. After the smartphone has verified its identity by sending the point-of-sale device a decrypted nonce that matches one received from the server, the point-of-sale device may display a picture of the user on its screen. The cashier may manually scan the user's groceries and may press the user's picture on the touch screen of the point-of-sale device. The payment for the groceries is performed by the server, and a result message confirming the transaction is displayed on the point-of-sale device's screen.

In some embodiments, client devices (or other devices associated with a user profile/account engaged in a transaction) may receive notifications from the server and/or the point-of-sale device in response to conducting a transaction. For example, a client mobile device may receive an SMS text message, a signal causing the device to buzz or rumble, and/or other out-of-band message indicating that a store purchased has occurred. In this way, registered users of client device may be made aware of transactions and potentially be made aware of any fraudulent or erroneous activity that otherwise might go undetected due to the passive nature of the embodiment systems.

In some embodiments, the point-of-sale device may display authentication data (e.g., digital pictures, audio samples, handwriting samples, etc.) provided by the server. Such displayed data may be used by operators of the point-of-sale device to verify the identity of a user of the client device, thereby providing a 2-factor authorization. For example, the point-of-sale device may render a picture of a registered user's face for comparison to the person in front of a cashier. In some embodiments, the operator may provide inputs to the point-of-sale device to confirm the identity of the user of the client device, such as by pressing on a displayed image on a touch screen.

In some embodiments, client device users registered with the server may be prompted to opt-into passive transaction programs (i.e., hands-free payment programs). Such opt-in (or opt-out) responses may be given by users via a registration portal and stored in user profiles associated with the server. In some embodiments, users of client devices may opt-in to passive transaction programs with particular retailers/entities, such as in response to walking into a retail store, installing a store app, etc. In various embodiments, based on user profile preferences, users of client devices may or may not be tracked and/or automatically provided with advertisements (e.g., SMS text coupons, in-band messages on store apps, etc.).

Some embodiments may utilize the communication system and platform described in U.S. patent application Ser. No. 13/773,379, titled “Platform for Wireless Identity Transmitter and System Using Short-Range Wireless Broadcasts,” filed Feb. 21, 2013 and U.S. patent application Ser. No. 13/833,227, titled “System for Delivering Relevant User Information Based on Proximity and Privacy Controls,” filed Mar. 15, 2013, the entire contents of both are hereby incorporated by reference. In particular, point-of-sale devices may be configured to periodically broadcast messages (e.g., Bluetooth LE advertisement packets, etc.) that include secure or rolling identifiers. Such broadcast messages may be received by proximate mobile devices and relayed to the server for resolving. When the resolved identifiers are recognized (e.g., match registered user or device identifiers), the server may respond to the proximate mobile devices with messaging indicating that the point-of-sale devices may be trusted for further communications regarding transactions (e.g., connection via Bluetooth link, etc.). Such embodiments may provide heightened security, and further may be beneficial over conventional techniques, as these embodiments may utilize battery-powered devices (e.g., broadcasting transmitters) that are weather-proof and may not require a backhaul, integrated into a large server-based platform that utilizes geofencing, proximity detections, profiles, analytics, and various APIs for different use cases, trusted device confirmations, customer permissions/opt-in procedures, and revenue models that may be based on usage (e.g., user volume).

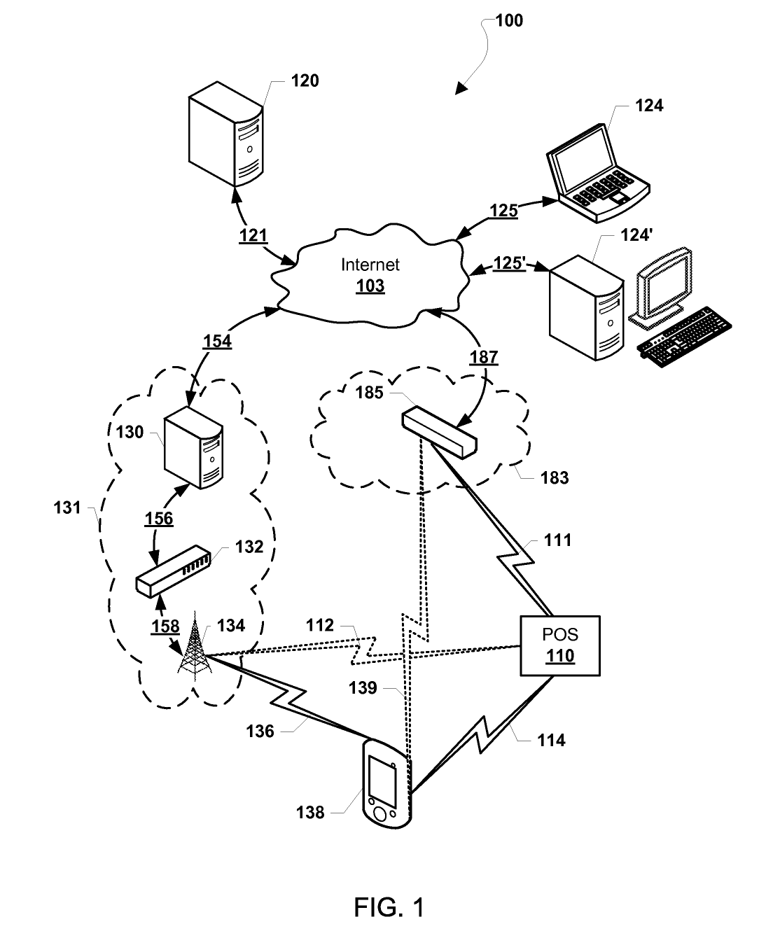

FIG. 1 illustrates an exemplary communication system 100 that may be used in various embodiments. The communication system 100 may include a server 120, a mobile device 138, such as a smartphone, tablet, etc., and a point-of-sale device 110 (referred to as “POS” in FIG. 1), such as a cash register computing device. The mobile device 138 and point-of-sale device 110 may be equipped with short-range wireless transmission capabilities, such as transceivers configured to transmit and receive Bluetooth packets. Thus, the mobile device 138 and point-of-sale device 110 may be capable of communicating via short-range wireless signals 114 when they are within proximity of each other. In some embodiments, the mobile device 138 and point-of-sale device 110 may communicate without the need to negotiate a direct communication link, such as by periodically broadcasting messages that may be collected automatically by any other device within broadcast range. For example, the mobile device 138 within a certain proximity may receive a broadcast message transmitted by a Bluetooth® transceiver within the point-of-sale device 110, and vice versa. In some embodiments, the mobile device 138 and/or the point-of-sale device 110 may transmit short-range wireless messages that include secure identifiers. Alternately, the short-range wireless signals 114 may include communications of an established wireless connection (or paired connection).

The short-range wireless signals 114 may be formatted and transmitted according to any of a variety of communication protocols, such as Bluetooth®, Bluetooth® LE®, Wi-Fi, Wi-Fi Direct, infrared wireless, induction wireless, ultra-wideband (UWB), wireless universal serial bus (USB), Zigbee®, Peanut®, or other short-range wireless technologies or protocols which have or which can be modified (e.g., by restricting transmit power) to limit their effective communication range to relatively short range (e.g., within about 100 meters). In some embodiments, the devices 138, 110 may use the low energy technology standardized in the Bluetooth® 4.0 protocol (or later versions). For example, in some embodiments, the devices 110, 138 may periodically broadcast packets configured as an advertiser as described in the Bluetooth® 4.0 protocol, and the devices 110, 138 may further be configured to act as scanners according to that protocol.

The Bluetooth® protocol and Bluetooth® devices (e.g., Bluetooth® LE devices) have a relatively short effective communication range, are widely used in deployed communication and computing devices, have standard advertising or pairing procedures that meets the discovery and reporting needs of various embodiments, and exhibit low power consumption, which make the protocol ideal for many applications of the various embodiments. For this reason, Bluetooth® and Bluetooth® LE protocols and devices are referred to in many of the examples herein for illustrative purposes. However, the scope of the claims should not be limited to Bluetooth® or Bluetooth® LE devices and protocol unless specifically recited in the claims. For example, Peanut® transceivers may be included within the mobile device 138 and may be used to transmit two-way communications with the point-of-sale device 110 also configured to utilize Peanut® short-range radio transmissions.

In some embodiments, the point-of-sale device 110 may be located in strategic places within a place, such as a retail store, and/or may be located in high traffic areas (e.g., along aisles of a retail store, at entry ways to buildings, etc.). The point-of-sale device 110 may have various functionalities. For example, the point-of-sale device 110 may function as or be included within cash registers and/or display units within a retail store.

The mobile device 138 may communicate with a cellular network 131 via long range wireless links 136 (or a wide area network connection) to one or more base stations 134 coupled to one or more network operations centers 132 by a wired or wireless connection 158. Such cellular network 131 may utilize various technologies, such as 3G, 4G, and the Long Term Evolution (LTE) communication standard. The network operations centers 132 may manage voice calls and data traffic through the cellular network 131, and typically may include or may be connected to one or more servers 130 by a wired or wireless connection 156. The servers 130 may provide a connection 154 to the Internet 103. In some embodiments, the point-of-sale device 110 may also communicate with the cellular network 131 via long range wireless links 112 to a base station 134, thus establishing a wide area network (WAN) connection via the links 112.

The point-of-sale device 110 may transmit signals to a wireless router 185 via wired or wireless connections 111. The wireless router 185 may be associated with a local area network 183 (e.g., a Wi-Fi network), and may provide a connection 187 to the Internet 103. For example, the point-of-sale device 110 may transmit messages to a Wi-Fi wireless router 185 that include data from messages (e.g., peripheral response messages) transmitted by the mobile device 138. Thus, the point-of-sale device 110 may establish a wide area network (WAN) connection via the router 185. In some embodiments, the mobile device 138 may also communicate with the wireless router 185 via a wireless link 139.

The server 120 may be connected to the Internet 103 via the connection 121 (i.e., a WAN connection), thereby allowing communication between the mobile device 138, the point-of-sale device 110, and the server 120. The server 120 may include a plurality of components, blades, or other modules to process messages and data received from devices 110, 138. Further embodiments may provide a direct connection (not shown) between the server 120 and any of the mobile device network components, such as the network operations servers 130, to more directly connect the devices 138, 110.

The communication system 100 may also include computing terminals 124, 124′, such as laptop computers or personal computers at home or work, connected to the Internet 103 via connections 125, 125′. Users may use the computing terminals 124, 124′ to communicate via the Internet 103 with the server 120. Such terminals 124 may allow users, such as customers, retailers, etc., to register create user profiles that may be associated with devices (e.g., mobile devices 138, point-of-sale devices 110, etc.). For example, users may use such terminals 124, 124′ to access web portals and/or user accounts associated with the server 120 to set permissions, authorizations, authentication data, identifying data, etc.

In some embodiments, the mobile device 138 may be configured to report contacts (or sightings) with the point-of-sale device 110 to the server 120 via the Internet 103, and vice versa. For example, the mobile device 138 may transmit a sighting message to the server 120 that includes a rolling identifier corresponding to the identity of the point-of-sale device 110 (or its registered owner). Each time the mobile device 138 receives an identifier from the point-of-sale device 110, the identifier may be associated with the time of the connection and the location of the mobile device 138, 142, and this information may be transmitted to the server 120, such as within a sighting message. Also, in some embodiments, the server 120 may store various data reported by sighting messages in a database, which may be used for locating, tracking or otherwise monitoring movements of the mobile device 138.

As described above, a point-of-sale device (referred to below as a “POS” device), a client mobile device (referred to below as a “client” device) used by a customer, and a remote or central server (referred to below simply as a “server”) may exchange various communications to enable convenient transactions based on proximity. For example, a customer carrying the client device within a retail store may walk up to a cash register point-of-sale device, causing the point-of-sale device and the client device to exchange short-range (e.g., Bluetooth) signals. In response, the point-of-sale device may contact the server and receive an image and other data of the customer. The point-of-sale device may send the data to be verified by the client device, at which time the point-of-sale device may display on its screen the image of the customer. The cashier operating the point-of-sale device may visually confirm that the customer matches the displayed image, and may interact with the displayed image to cause a check-out or payment transaction to be performed by the server. For example, the point-of-sale device may transmit a list of items the customer intends to purchase, and the server may utilize pre-stored financial information of the verified customer to pay for the items. In this way, the customer may not have to pull out a wallet, phone, or any other information/device in order to successfully purchase items, but instead simply walk to point-of-sale devices and rely upon his/her established server profiles.

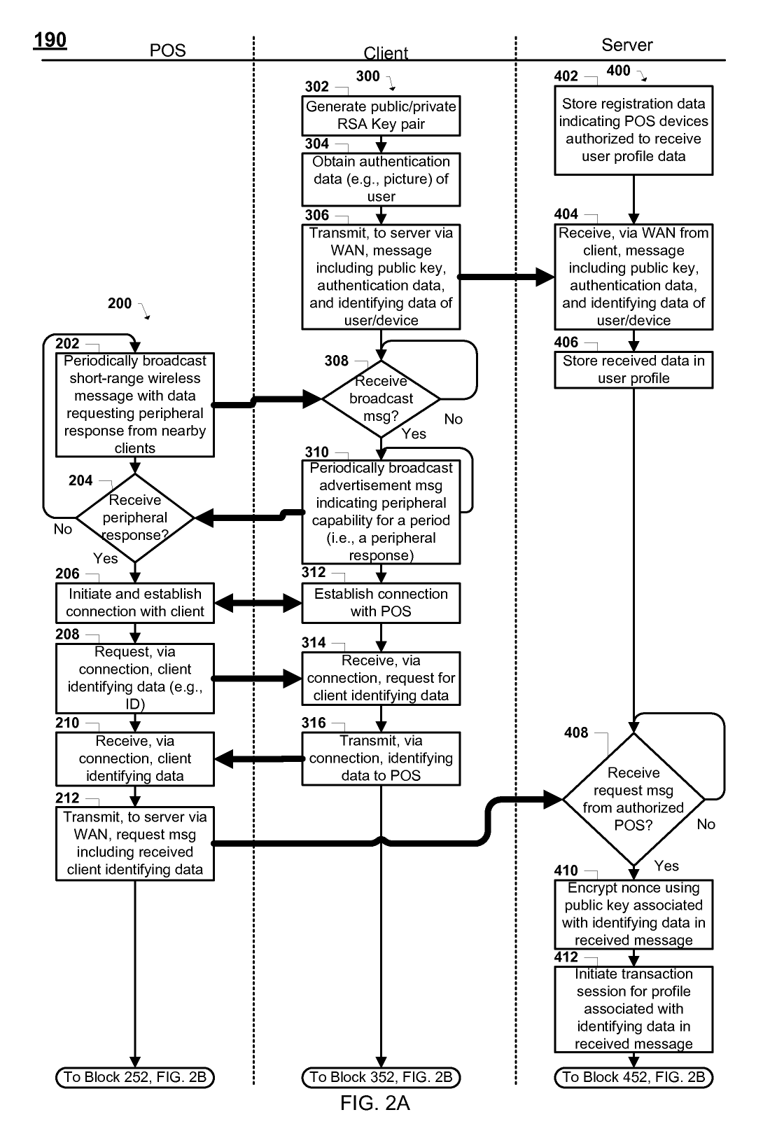

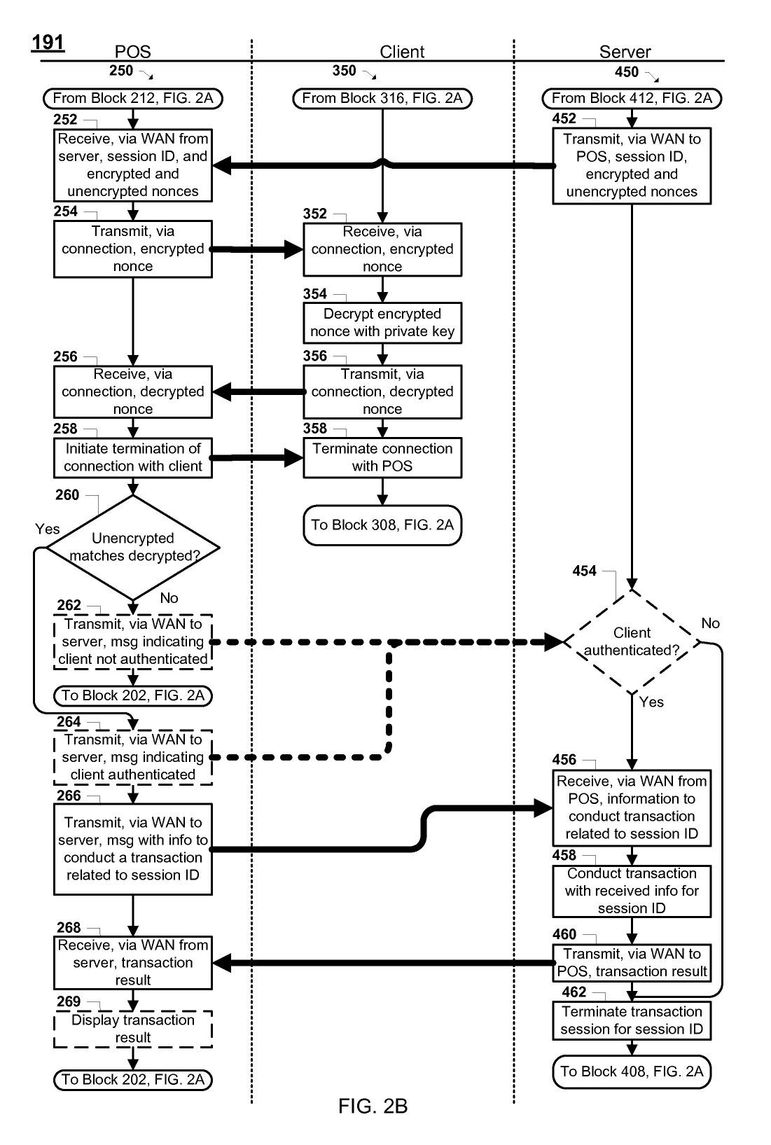

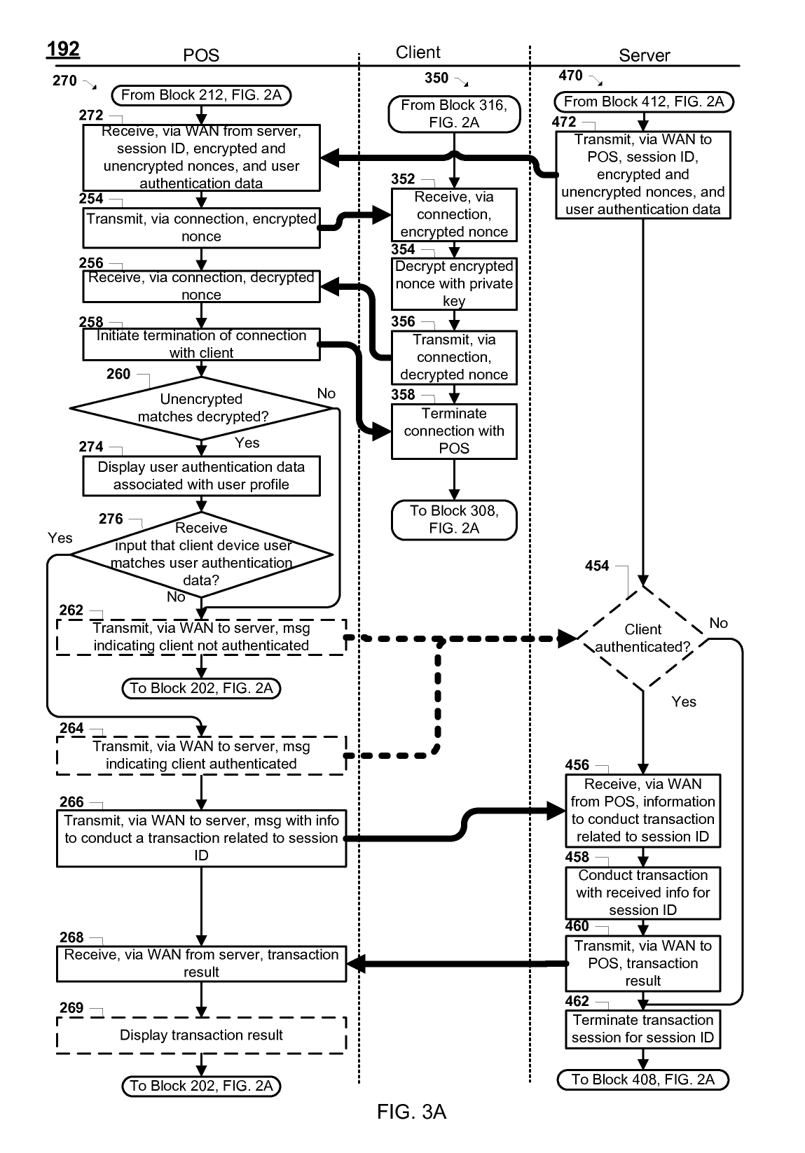

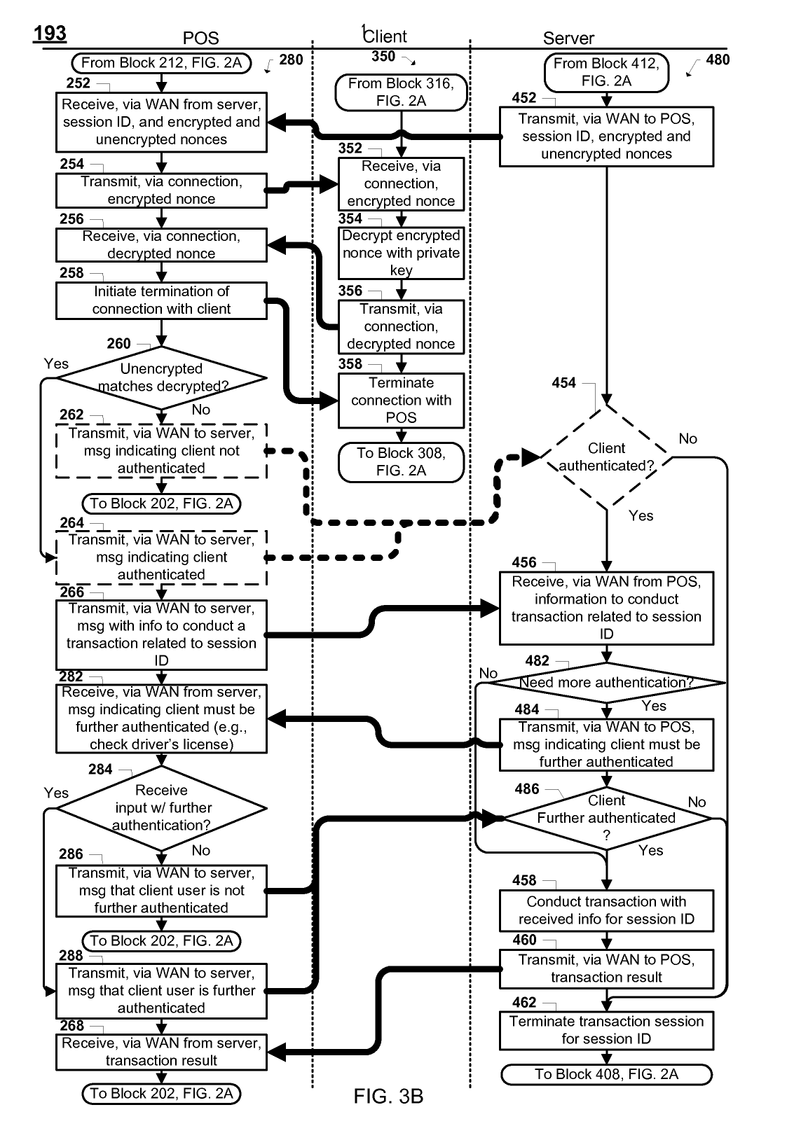

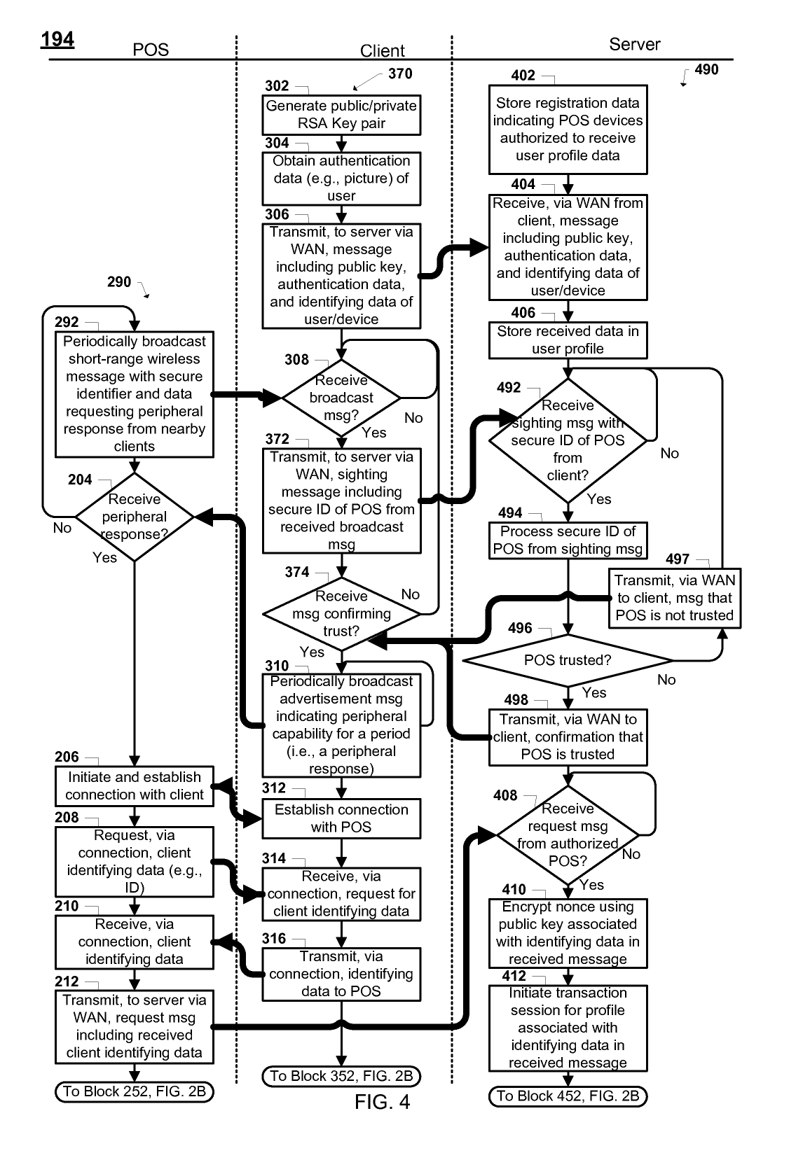

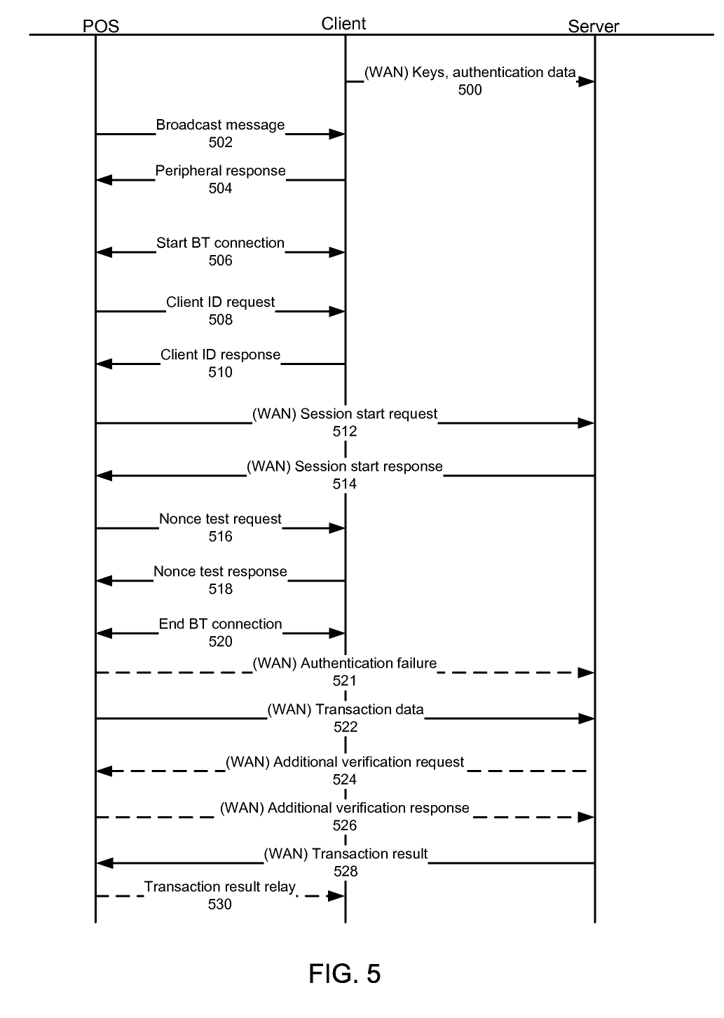

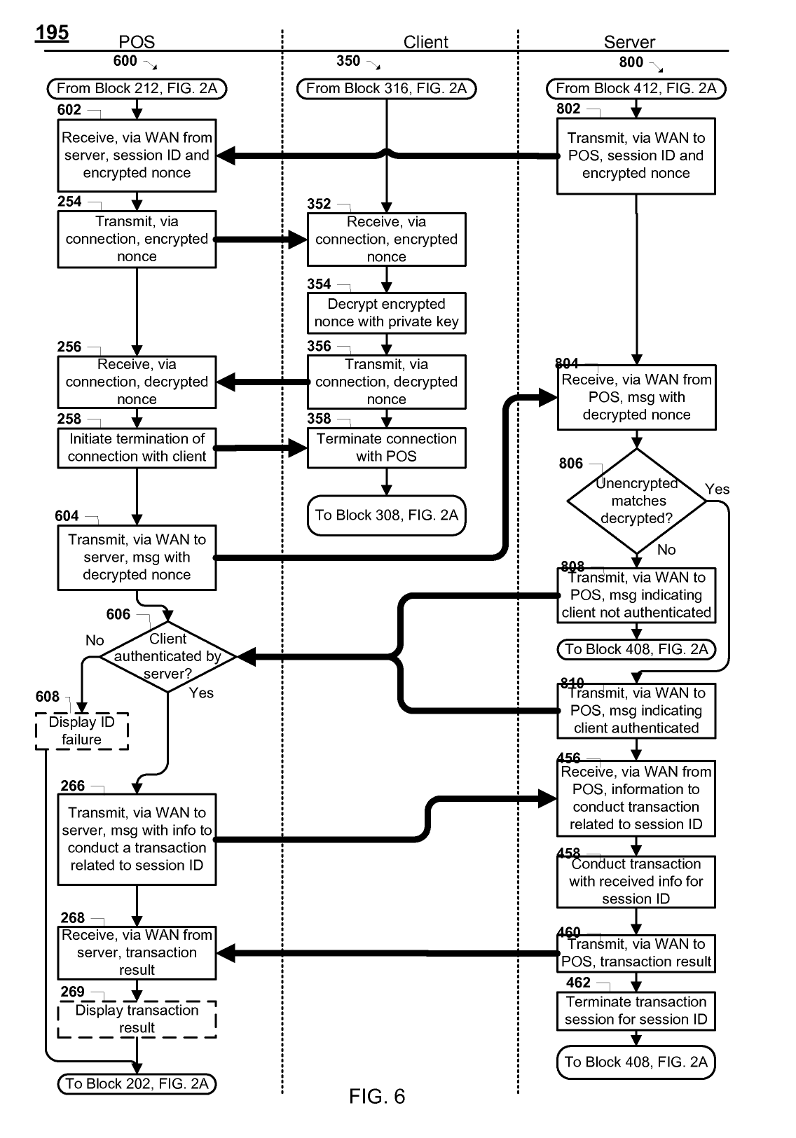

FIGS. 2A-2B, 3A-3B, 4 and 6 illustrate various system methods 190-195 encompassing embodiment methods executed by a point-of-sale device or “POS” (i.e., methods 200, 250, 270, 290 and 600), a client device (i.e., methods 300, 350, and 370), and a server (i.e., methods 400, 450, 470, 490 and 800) for exchanging communications in order to conduct transactions.

It should be appreciated that the various embodiment methods described with reference to FIGS. 2A-2B, 3A-3B, 4 and 6 may be performed in tandem by the POS, client and server devices. For example, the point-of-sale device may perform the methods 200, 250 of FIGS. 2A-2B, the client device may perform the methods 300, 350 of FIGS. 2A-2B, and the server may perform the methods 400, 450 of FIGS. 2A-2B at the same time. It should also be appreciated that the FIGS. 2A-2B, 3A-3B, 4 and 6 illustrate embodiment methods that may be performed by the related devices in an interchangeable manner. For example, the point-of-sale device may be configured to perform either the operations of the method 200 or method 290 in combination with the operations of any one of the methods 250, 270, 280, or 600 at any given time. As another example, the client device may be configured to perform either the operations of the method 300 or method 370 in combination with the operations of the method 350 at any given time. As another example, the server may be configured to perform either the operations of the method 400 or method 490 in combination with the operations of any one of the methods 450, 470, 480, or 800 at any given time. As a further example, on a system-scale, either the system method 190 of FIG. 2A or the system method 194 of FIG. 4 may be performed in combination with any one of the system methods 191-193, or 195 of FIG. 2B, 3A-3B, or 6, respectively.

FIG. 2A illustrates an embodiment system method 190 that includes individual device methods 200, 300, 400 that may be performed in tandem by a point-of-sale device, a client device, and a server, respectively. Further, FIG. 2B illustrates an embodiment system method 191 that includes individual device methods 250, 350, 450 that may be performed in tandem by the point-of-sale device, the client device, and the server, respectively. As described above, the embodiment system methods 190 and 191 may be performed in combination.

Referring to method 300, in block 302, the processor of the client device may generate a public/private RSA key pair including a public key and a private key (or an encryption key pair), wherein the private key is utilized only by the client device and the public key may be used by trusted devices (e.g., the server). Such key pairs may be generated by the client device by executing routines, processes, etc. configured to utilize standard RSA algorithms and techniques. In block 304, the processor of the client device may obtain authentication data (e.g., picture) of user, such as by using a camera coupled to the client device to capture a digital photograph of the user of the client device (e.g., a customer's face). In block 306, the processor of the client device may transmit, to the server via a WAN connection (i.e., the Internet), a message including the generated public key, the obtained authentication data, and identifying data of user/device (e.g., a device identifier, a username, etc.). In various embodiments, the WAN connection may be a connection to a cellular network via a cellular radio/modem and/or a connection to the Internet via a Wi-Fi router associated with a local area network (LAN), such as a retail store LAN.

Referring to method 400, in block 402, the server (or a processor within a server) may store registration data indicating point-of-sale devices authorized to receive user profile data. In particular, the server may store profiles for all devices, such as point-of-sale devices in retail stores and/or mobile devices used by customers, that are eligible or otherwise registered to utilize the server for conducting transactions. Such registrations may be done ahead of time via various devices connected to the Internet. For example, a personal computer may log into a registration portal to register various point-of-sale devices of a retail store, mobile devices of a customer, etc. In block 404, the server may receive, via the WAN (i.e., the Internet) from the client device, the message including the public key, the authentication data, and the identifying data of user and/or the client device. In block 406, the server may store the received data in a user profile associated with the client device and/or its user. In some embodiments, the receipt of the message in block 404 may cause the server to register (or sign-up) the client device and/or its user or, alternatively, the receipt of the message may simply cause the server to update a user profile already stored by the server (i.e., the client device and/or its user may already have registered).

Referring to method 200, in block 202, the processor of the point-of-sale device may periodically broadcast a short-range wireless message with data requesting a peripheral response from nearby client devices. The broadcast message may be a non-connectable message that includes codes or other information predefined to trigger actions by certain recipient devices (e.g., devices with the radio functionality and within proximity). In particular, the broadcast messages may include information that requests recipient devices configured to operate as Bluetooth peripherals to temporarily activate that functionality and also respond with a message stating its availability. In some embodiments, the broadcast message may be an advertisement packet, such as packet conforming to a Bluetooth Low Energy (BTLE) protocol. The point-of-sale device may be configured to broadcast the message at various intervals indefinitely, and therefore may be considered to act as a beacon device with regard to the request for peripheral responses. In some embodiments, the point-of-sale device may be configured to broadcast messages that include secure or rolling identifiers that may be resolved at the server. Such techniques are described in U.S. patent application Ser. No. 13/773,379, titled “Platform for Wireless Identity Transmitter and System Using Short-Range Wireless Broadcasts,” filed Feb. 21, 2013 and U.S. patent application Ser. No. 13/773,336, titled “Preserving Security By Synchronizing a Nonce or Counter Between Systems,” filed Feb. 21, 2013.

Returning to the method 300, in determination block 308, the processor of the client device may determine whether it has received the broadcast message from the point-of-sale device. For example, the client device may be configured to periodically monitor a receiving circuit related to incoming Bluetooth Low Energy signals. In response to determining that the broadcast message from the point-of-sale device is not received (i.e., determination block 308=“No”), the client device may continue to monitor for incoming broadcast message in determination block 308. However, in response to determining that the broadcast message from the point-of-sale device is received (i.e., determination block 308=“Yes”), the client device may begin periodically broadcasting for a period of time an advertisement message indicating a peripheral capability (i.e., a peripheral response) in block 310. For example, the advertisement message may include data that indicates the client device is configured to operate as a Bluetooth peripheral that nearby devices having Bluetooth functionalities may connect to. The advertisement message may be a non-connectable signal that may include various other information needed for nearby devices to connect to the client device in a peripheral capacity, such as a networking identifier, media access control (MAC) address, etc. The client device may continue to broadcast the advertisement message for a predefined period, such as a number of seconds after receiving the broadcast message from the point-of-sale device.

Returning to the method 200, in determination block 204, the processor of the point-of-sale device may determine whether it has received a peripheral response from a nearby client device, such as a standard on-pairing advertisement indicating that Bluetooth peripheral functionality is available. In response to determining that no peripheral response is received (i.e., determination block 204=“No”), the point-of-sale device may continue periodically broadcasting messages in block 202. However, in response to determining that a peripheral response is received (i.e., determination block 204=“Yes”), the processor of the point-of-sale device may initiate and establish a short-range wireless connection with the client device in block 206. The connection may be peer-to-peer wireless connection of various communication protocols, such as Bluetooth or Wi-Fi Direct. The point-of-sale device may utilize data from the received peripheral response, such as information required to pair or bond with the client device. In some embodiments, an operator of the point-of-sale device, such as a cashier, may be presented with information indicating that the peripheral response has been received and should be confirmed before further operations with the client device are performed. For example, a message may be displayed on the display of the point-of-sale device indicating that the cashier needs to select “OK” before starting a Bluetooth connection with a client device of a customer waiting in a check-out line. Returning to the method 300, in block 312, the processor of the client device may establish a connection with the point-of-sale device in response to the point-of-sale device's actions to initiate the connection.

Returning to the method 200, in block 208, the processor of the point-of-sale device may send a request message via the established connection asking the client device to send identifying data, such as a client identifier (or client ID), username, and/or any other information stored on the client device that may be used to associate the client device or its user with a user profile stored on the server. Such a request transmission may be referred to below as a “client ID request”. Returning to the method 300, in block 314, the processor of the client device may receive, via the short-range wireless connection, the request for identifying data (e.g., client ID, etc.). In block 316, the processor of the client device may transmit, via the short-range wireless connection, the identifying data to the point-of-sale device. Returning to the method 200, in block 210, the processor of the point-of-sale device may receive, via the short-range wireless connection, the client identifying data. Such a received transmission may be referred to below as a “client ID response”.

In block 212, the processor of the point-of-sale device may transmit, to the server via the WAN (e.g., via a WAN connection using Internet protocols), a request message including the received client identifying data. For example, the point-of-sale device may use a Wi-Fi connection or a cellular network connection to transmit a message over the Internet to the server that indicates a transaction should be conducted in response to the client device being within proximity of the point-of-sale device. The request message (also referred to as a “session start request”) may indicate that the point-of-sale device requires a session to be established at the server with which the server may perform various operations for charging accounts (or checking-out) and/or otherwise using stored user profile data to facilitate an interaction between the point-of-sale device and the client device (or its user). The request message may include various information about the point-of-sale device, such as its device identifier and/or information indicating a user profile associated with the point-of-sale device and/or its owner (e.g., a retailer, etc.). Returning to the method 400, in determination block 408, the server may determine whether it received the request message from an authorized point-of-sale device. In other words, in response to determining that a request message has been received, the server may compare information within the request message regarding the point-of-sale device to stored data to determine whether the point-of-sale device is registered with the server (e.g., is associated with a stored user profile, etc.) and is authorized to receive information about the client device and/or its user. For example, the server may evaluate permissions information stored with a user profile matching the client device identifier from the received request message from the point-of-sale device to identify whether the client device (or its user) have registered for payment services to be conducted related to the point-of-sale device (or a retail store associated with the point-of-sale device). In some embodiments, the server may determine that the point-of-sale device is authorized based on authentication information within the request message.

In response to determining that the server has not received a request message from an authorized point-of-sale device (i.e., determination block 408=“No”), the server may continue monitoring for incoming request messages in determination block 408. However, in response to determining that the server has received a request message from an authorized point-of-sale device (i.e., determination block 408=“Yes”), the server may encrypt a nonce using the public key associated with identifying data in the received message in block 410. In other words, the server may use the client ID of the client device indicated in the received request message from the point-of-sale device to perform a look-up to find the user profile associated with the client ID. With the found user profile associated with the client device, the server may take the stored public key previously received from the client device (i.e., with the operations in block 404 described above) to encrypt a piece of information (e.g., counter, word, etc.), using an encryption algorithm known to the client device. The server may store the unencrypted data (i.e., unencrypted nonce) for eventual transmission to the point-of-sale device along with the encrypted data (i.e., encrypted nonce). In block 412, the server may initiate a transaction session for the user profile associated with identifying data of the client device in the received message. For example, the server may begin a check-out session for conducting a transaction related to the client device being used to purchase goods from a retailer associated with the point-of-sale device. The initiated session may be associated with a session identifier (or session ID) that may be used to reference the transaction session. The server may continue with operations in block 452 of the method 450 in FIG. 2B, the point-of-sale device may continue with operations in block 252 of the method 250 in FIG. 2B, and the client device may continue with the operations in block 352 of the method 350 in FIG. 2B. In other embodiments, the server may continue with operations in block 472 of method 470 in FIG. 3A, the point-of-sale device may continue with operations in block 272 of method 270 in FIG. 3A, and the client device may continue with the operations in block 352 of method 350 in FIG. 3A. In other embodiments, the server may continue with operations in block 452 of method 480 in FIG. 3B, the point-of-sale device may continue with operations in block 252 of method 280 in FIG. 3B, and the client device may continue with the operations in block 352 of method 350 in FIG. 3B. In other embodiments, the server may continue with operations in block 802 of method 800 in FIG. 6, the point-of-sale device may continue with operations in block 602 of method 600 in FIG. 6, and the client device may continue with the operations in block 352 of method 350 in FIG. 6.

Referring to system method 191 of FIG. 2B, in block 452 of method 450, the server may transmit, via the WAN (i.e., via its WAN connection) to the point-of-sale device, a session ID, the encrypted nonce and the unencrypted nonce. Such a transmission may be referred to below as a “session start response”. In some embodiments, the server may also transmit authentication data associated with the client device, such as images, that may be used by the operator of the point-of-sale device to perform visual verification of the user of the client device. Referring to method 250 of FIG. 2B, in block 252, the processor of the point-of-sale device may receive, via the WAN from the server (e.g., via its WAN connection), the session ID, and the encrypted and the unencrypted nonces. In response, in block 254, the processor of the point-of-sale device may transmit, via the short-range wireless connection with the client device, the encrypted nonce. This transmission may be referred to below as a “nonce test request”. Referring to method 350 of FIG. 2B, in block 352, the processor of the client device may receive, via the short-range wireless connection with the point-of-sale device, the encrypted nonce. In response, in block 354, the processor of the client device may decrypt the encrypted nonce with the private key generated with the operations in block 302. For example, the client device may perform a decryption algorithm, application, function, instruction, and/or routine using the private key in order to generate a decrypted piece of information. In block 356, the processor of the client device may transmit, via the short-range wireless connection to the point-of-sale device, the decrypted nonce. Returning to the method 250, in block 256, the processor of the point-of-sale device may receive, via the short-range wireless connection with the client device, the decrypted nonce. This received transmission may be referred to below as a “nonce test response”. In block 258, the processor of the point-of-sale device may initiate the termination of the short-range wireless connection with the client device, such as by transmitting an end signal or simply terminating the connection in a unilateral manner. In a similar way, in the method 350, the processor of the client device may perform operations to terminate or otherwise close the connection in block 358. The client device may continue with the operations for monitoring for subsequent broadcast messages (i.e., beacon messages), such as with the operations in block 308 of the method 300 in FIG. 2A. In other embodiments, the client device may continue with the operations for monitoring for subsequent broadcast messages in block 308 of the method 370 described below.

Returning to the method 250, in determination block 260, the processor of the point-of-sale device may determine whether the unencrypted nonce received from the server matches the decrypted nonce received from the client device. As the encrypted nonce was encrypted by the server using a particular public key, only the corresponding private key may be used to decrypt the encrypted nonce to obtain the unencrypted nonce. Therefore, if the decrypted nonce received from the client device matches the unencrypted nonce, the client device can be verified (or authenticated) as the actual client device associated with the identifying data received by the point-of-sale device in block 210 as described above. In response to determining that the unencrypted nonce received from the server does not match the decrypted nonce received from the client device (i.e., determination block 260=“No”), the client device may be considered unverified or unauthenticated, and thus, no transaction may occur between the point-of-sale device and the user of the client device. In optional block 262, the processor of the point-of-sale device may transmit a message to the server via the WAN (i.e., via the point-of-sale device's WAN connection) indicating that the client device has not been authenticated, and may continue with the operations in block 202 as described above for transmitting the broadcast message as a beacon. In some embodiments, the point-of-sale device may continue with the operations in block 292 of the method 290 in FIG. 4.

However, in response to determining that the unencrypted nonce received from the server matches the decrypted nonce received from the client device (i.e., determination block 260=“Yes”), the client device may be considered authenticated (or verified), and thus, a transaction may occur between the point-of-sale device and the user of the client device. In optional block 264, the processor of the point-of-sale device may transmit, via the WAN to the server, a message indicating that the client device has been authenticated. In some embodiments, the point-of-sale device may also display a message to the operator of the point-of-sale device indicating that the client device has been authenticated, such as a by rendering on a touch screen an image of the user of the client device that may be interfaced in order to proceed with a check-out or other transaction. In block 266, the processor of the point-of-sale device may transmit, via the WAN to the server, a message with information to conduct a transaction related to the session ID received from the server. For example, the information may include identifiers of items and their associated prices that the user of the client device intends to purchase via the point-of-sale device. In some embodiments, the information may further include other data, such as sales tax, service fees/charges, gratuity amounts, and other information that may be needed to check-out and otherwise charge the user of the client device with regard to a transaction. In some embodiments, the information transmitted via the messages of optional block 264 and block 266 may be included in a single transmission. For example, the point-of-sale device may transmit a single message that confirms (or authenticates) the identity of the client device as well as provides information for conducting a check-out procedure.

Returning to the method 450, in optional determination block 454, the server may determine whether the client device has been authenticated based on matching the unencrypted nonce with a decrypted nonce provided to the point-of-sale device by the client device. The server may make this determination based on information in messages received from the point-of-sale device, such as codes or data indicating that the client device was or was not able to properly decrypt the encrypted nonce. In response to determining that the client device is authenticated (i.e., optional determination block 454=“Yes”), or simply in response to the server performing the operations in block 452, the server may receive, via the WAN from the point-of-sale device, the information to conduct the transaction related to the session ID in block 456. In block 458, the server may conduct a transaction with the received information related to the session ID, such as by charging an account associated with the client device. In some embodiments, the server may transmit various messages during or in response to conducting the transaction, such as sending signals to the client device indicating the transaction that may be viewed by a user of the client device to detect fraudulent charges or simply confirm the correction of the transaction. In block 460, the server may transmit, via the WAN to the point-of-sale device, a transaction result, such as an indication of a successful transaction or a failed or rejected transaction. For example, the transaction result may indicate that a charge was successfully made on a user's account, or alternatively that there was an error encountered that precluded the completion of a purchase transaction.

In response to determining that the client device is not authenticated (i.e., optional determination block 454=“No”) or in response to performing the operations in block 460, the server may terminate the transaction session for the session ID in block 462, and may continue with the operations for monitoring for incoming request messages in determination block 408. In some embodiments, the server may continue with the operations for monitoring for incoming sighting messages in determination block 492 of the method 490 in FIG. 4.

Returning to the method 250, the processor of the point-of-sale device may receive, via the WAN from the server, the transaction result in block 268, and may display the transaction result in optional block 269, such as by rendering a message on a monitor and/or emitting a noise through speakers to indicate the successful completion or failure of the transaction. The point-of-sale device may continue with the operations for periodically broadcasting short-range wireless messages as a beacon in block 202. In some embodiments, the point-of-sale device may continue with the operations in block 292 of the method 290 described below.

FIG. 3A illustrates an embodiment system method 192 that is comprised of individual device methods 270, 350, 470 that may be performed in tandem by a point-of-sale device, a client device, and a server, respectively. As described above, the embodiment system methods 190 and 192 may be performed in combination. The embodiment method 270 and the embodiment method 470 may be performed by a point-of-sale device and a server, respectively, for authenticating a user of a client device in a two-step manner. The methods 270 and 470 are similar to the methods 250 and 450 described above with reference to FIG. 2B, except that the method 470 may include operations for the server to transmit user authentication data along with nonces and the method 270 may include operations for the point-of-sale device to display the user authentication data. The operations of the method 350 for the client device are the same as described above with reference to FIG. 2B. In this way, the point-of-sale device and its operator (e.g., a cashier) may be capable of authenticating the client device and the user of the client device to ensure nefarious parties have not wrongfully acquired a client device.

Referring to the method 470 of FIG. 3A, in block 472, the server may transmit, via the WAN to the point-of-sale device, the session ID, the encrypted and unencrypted nonces, and the user authentication data from the user profile associated with the client ID received from the point-of-sale device with the operations of determination block 408 described above. The user authentication data may include images, such as digital pictures, of the user associated with the user profile associated with the client ID. In other embodiments, the user authentication data may include other stored data in the user profile that may be used to confirm the identity of the user of the client device near the point-of-sale device, such as voice samples and handwriting samples. The server may continue with the operations in blocks 454-462 as described above.

Referring to the method 270 of FIG. 3A, in block 272, the processor of the point-of-sale device may receive, via the WAN from the server, the session ID, the encrypted and unencrypted nonces, and the user authentication data. The point-of-sale device may perform the operations in blocks 254-260 as described above. In response to determining that the unencrypted nonce received from the server matches the decrypted nonce received from the client device (i.e., determination block 260=“Yes”), the processor of the point-of-sale device may display the user authentication data associated with the user profile associated with the identifying data (i.e., client ID received from the client device) in block 274. For example, the point-of-sale device may render a photo, a handwriting sample, and/or an audio sample of the registered user associated with the server-stored user profile connected to the client ID. In determination block 276, the processor of the point-of-sale device may determine whether it has received an input that indicates the client device user matches the user authentication data. For example, the operator of the point-of-sale device may press on a rendered image of the user in order to confirm the image matches the user of the client device standing in front of the point-of-sale device in a check-out line. As another example, the operator of the point-of-sale device (e.g., cashier) may press a “reject” button on a touch screen coupled to the point-of-sale device to indicate the user of the client device does not match the image received from the server. In response to determining that an input indicating that the client device user does not match the user authentication data (i.e., determination block 276=“No”), as described above with reference to FIG. 2B, in optional block 262, the processor of the point-of-sale device may transmit, via the WAN to the server, a message indicating that the client device has not been confirmed, and may continue with the operations for transmitting the broadcast message as a beacon as described above. However, in response to determining that an input indicating that the client device user matches the user authentication data (i.e., determination block 276=“Yes”), the processor of the point-of-sale device may continue with the operations in blocks 264-269 as described above.

FIG. 3B illustrates an embodiment system method 193 that is comprised of individual device methods 280, 350, 480 that may be performed in tandem by a point-of-sale device, a client device, and a server, respectively. As described above, the embodiment system methods 190 and 193 may be performed in combination. The embodiment method 280 and the embodiment method 480 may be performed by a point-of-sale device and a server, respectively, for authenticating a user of a client device prior to conducting a transaction.

The methods 280 and 480 are similar to the method 250 (or 270) and the method 450 (or 470), respectively, as described above with reference to FIG. 2B (or FIG. 3A), except that the method 480 may include operations for the server to transmit messages to the point-of-sale device indicating that the operator of the point-of-sale device should perform additional verifications of the user of the client device, and the method 280 may include operations for the point-of-sale device to prompt its operator to perform the additional verifications. For example, a cashier may be prompted to check a driver's license of the user of the client device prior to authorizing a check-out or purchase transaction. In some embodiments, such additional verifications may only be performed one time for each customer and/or point-of-sale device. The operations of the method 350 for the client device are the same as described above with reference to FIG. 2B.

Referring to the method 480 of FIG. 3B, the operations in blocks 452-456 may be similar to as described above. In determination block 482, the server may determine whether additional authentication is needed. For example, the server may identify a flag or other indicator associated with the user profile linked to the identifying data (e.g., client ID) received from the point-of-sale device that indicates further verification is required before purchases or other transactions may be automatically conducted. Such a transmission from the server may be referred to below as an “additional verification request”. In various embodiments, additional authentication may be described in the user profile associated with the client ID (e.g., check driver's license, do a visual confirmation, ask for pass code, etc.), or alternatively may be the same for all registered users. In response to determining that no additional authentication is required (i.e., determination block 482=“No”), the server may continue with the operations in block 458 as described above. However, in response to determining that additional authentication is required (i.e., determination block 482=“Yes”), the server may transmit, via the WAN to the point-of-sale device, a message (referred to below as an “additional authentication request”) indicating that the client device and/or its user must be further authenticated in block 484. The message may include instructions for the point-of-sale device and/or its operator (e.g., cashier) to carry-out the additional authentication.

Referring to the method 280 of FIG. 3B, the operations in blocks 252-266 may be similar to as described above. In block 282, the processor of the point-of-sale device may receive, via the WAN from the server, the message indicating that the client device (or its user) must be further authenticated. For example, the message may cause the point-of-sale device to render a message to its operator instructing him/her to check the driver's license of the user of the client device against user authentication data (e.g., digital image, etc.) within the message. In determination block 284, the processor of the point-of-sale device may determine whether it has received an input that indicates the client device user is further authenticated, such as an operator input on a touch screen indicating that the client device and its user are confirmed or not confirmed. In response to determining that the point-of-sale device has not received an input that the client device user is not further authenticated (i.e., determination block 284=“No”), the processor of the point-of-sale device may transmit, via the WAN to the server, a message that the client device user is not further authenticated in block 286 (such a message may be referred to below as an “additional verification response”), and may continue with the operations in block 202 as described above for periodically broadcasting the broadcast message as a beacon. In response to determining that the point-of-sale device has received an input that the client device user is not further authenticated (i.e., determination block 284=“Yes”), the processor of the point-of-sale device may transmit, via the WAN to the server, a message that the client device user is further authenticated in block 288 (such a message may be referred to below as an “additional verification response”), and may continue with the operations in block 268 as described above.

Returning to the method 480, in determination block 486, the server may determine whether the client device user is further authenticated based on responses received from the point-of-sale device. In response to determining that the client device user is further authenticated (i.e., determination block 486=“Yes”), the server may continue with the operations in block 458 for conducting the transaction as described above. In response to determining that the client device user is not further authenticated (i.e., determination block 486=“No”), the server may continue with the operations in block 462 for terminating the session as described above.

FIG. 4 illustrates an embodiment system method 194 that is comprised of individual device methods 200, 370, 490 that may be performed in tandem by a point-of-sale device, a client device, and a server, respectively. As described above, the embodiment system method 194 may be performed in combination with any of the system methods 191-193, 195 as described herein. The embodiment method 200, the embodiment method 370, and the embodiment method 490 of FIG. 4 may be performed by a point-of-sale device, a client device, and a server, respectively, for authenticating a point-of-sale device based on a secure identifiers (e.g., rolling identifiers) within broadcast messages received at the client device. In some embodiments, broadcast messages periodically transmitted by point-of-sale devices may include secure identifiers (e.g., rolling identifiers). Upon receipt of such broadcast messages, client devices may be unable to decrypt the included information to authenticate or otherwise identify the point-of-sale devices. Client devices may be configured to contact servers to securely authenticate point-of-sale devices prior to the client devices enabling themselves as Bluetooth peripherals and becoming available for connection by the point-of-sale devices. For example, client devices may relay secure identifiers from point-of-sale devices to the server for resolution and confirmation of a trusted or registered status of the point-of-sale devices. Systems for broadcasting, relaying, and processing such broadcast message with secure or rolling identifiers may be described in detail in at least U.S. patent application Ser. No. 13/773,379, titled “Platform for Wireless Identity Transmitter and System Using Short-Range Wireless Broadcasts,” filed Feb. 21, 2013 and U.S. patent application Ser. No. 13/773,336, titled “Preserving Security By Synchronizing a Nonce or Counter Between Systems,” filed Feb. 21, 2013, the contents of which are herein incorporated by reference.

The methods 290, 370 and 490 illustrated in FIG. 4 are similar to the methods 200, 300 and 400 described above with reference to FIG. 2A, respectively, except that the method 200 may include operations for the point-of-sale device to broadcast messages including a secure identifier (e.g., a rolling identifier), the method 490 may include operations for the server to process the secure identifier, and the method 370 may include operations for the client device to broadcast peripheral responses only when the point-of-sale device is determined to be trusted based on the server's processing of the secure identifier.

Referring to the method 290 of FIG. 4, the point-of-sale device may periodically broadcast short-range wireless messages (i.e., broadcast messages) with a secure identifier and data requesting peripheral responses from nearby client devices. The operations in block 292 are similar to the operations in block 202 described above, except the broadcast messages may include a secure identifier that may be resolved by the server to determine the true identity of the point-of-sale device. The operations in blocks 204-212 may be similar to as described above.

Referring to the method 370 of FIG. 4, the operations of blocks 302-308 may be as described above. In response to determining that the client device has received a broadcast message from the point-of-sale device (i.e., determination block 308=“Yes”), the processor of the client device may transmit, to the server via the WAN, a sighting message including the secure identifier (e.g., rolling identifier) of the point-of-sale device from received broadcast message in block 372. In various embodiments, the sighting message may include other information related to the client device, such as the client device identifier, a timestamp, sensor data, GPS coordinates, authentication information (e.g., secret keys, passes, special codes, digital certificates, etc.) that may be used by a server to confirm the identification (or identification information) of the client device, part or all of the information encoded in received broadcast messages, including any obscured or encrypted information, etc. For example, the sighting message may include a code from a hash function that can be decoded by the server to ensure the client device is associated with a particular registered user account/profile.

Referring to the method 490 of FIG. 4, the operations of blocks 402-406 may be as described above. In determination block 492, the server may determine whether it has received the sighting message with the secure identifier of the point-of-sale device from the client device. For example, the server may continually monitor an incoming message buffer for messages including particular metadata, header information, codes, etc. that indicate the presence of secure identifiers. In response to determining that no sighting message is received (i.e., determination block 492=“No”), the server may continue with the operations in determination block 492. However, in response to determining that a sighting message is received (i.e., determination block 492=“Yes”), the server may process the secure identifier from the sighting message to identify the point-of-sale device in block 494, such as by decrypting the secure identifier and matching it to known, registered identifiers. Various methods for resolving secure or rolling identifiers are described in U.S. patent application Ser. No. 13/773,336, the entire contents of which are herein incorporated by reference.

Based on the operations in block 494, in determination block 496, the server may determine whether the point-of-sale device associated with the secure identifier in the sighting message can be trusted by the client device. In other words, if the secure identifier is determined to be associated with a registered account (or profile) stored on the server, the point-of-sale device may be considered trustworthy. In some embodiments, the server may also evaluate permissions stored within the user profile of the client device indicating the types and identifiers of point-of-sale devices that may be trusted and/or authorized for communications with the client device. For example, only when a resolved secure identifier of a known point-of-sale device is also listed in the client device's profile as trusted (or authorized) may the server deem the point-of-sale device as trusted for direct communications with the client device. In response to determining that the point-of-sale device is not trusted by the client device (i.e., determination block 496=“No”), the server may transmit, via the WAN to the client device, a message indicating that the point-of-sale device is not trusted in block 497, and may continue with the operations for monitoring for subsequent sighting messages in determination block 492. In response to determining that the point-of-sale device is trusted by the client device (i.e., determination block 496=“Yes”), the server may transmit, via the WAN to the client device, a message indicating that the point-of-sale device is trusted in block 498, and may continue with the operations for monitoring for messages from the point-of-sale device in determination block 408 as described above.

Returning to the method 350, in determination block 374, the processor of the client device may determine whether a message confirming the trustworthiness of the point-of-sale device is received from the server. For example, a received trust confirmation message may indicate the point-of-sale device can be trusted (or is authorized) by the client device for subsequent communications. In response to determining that no message confirming the trustworthiness of the point-of-sale device is received from the server (i.e., determination block 374=“No”), the client device may continue with the operations of determination block 308 for monitoring for subsequent broadcast messages from point-of-sale devices. In some embodiments, the client device may determine that no confirmation message of the trustworthiness is received when a message is received indicating that the point-of-sale device is not trustworthy or, alternatively, the client device does not receive any confirmation message related to the trustworthiness of the point-of-sale device within a certain time period.

In response to determining that a message confirming the trustworthiness of the point-of-sale device is received from the server (i.e., determination block 374=“Yes”), the client device may make itself available for connecting as a peripheral, such as via a Bluetooth paired connection, and continue with the operations of block 310 for periodically broadcasting the advertisement message. The client device may continue with the operations of blocks 310-316 may be as described above.

FIG. 5 illustrates exemplary communications between a point-of-sale device, a client device, and a server in accordance with some embodiments as described above. It should be appreciated that the communications or messages 500, 512, 514, 522, 524, 526, and 528 may be transmitted over a wide area network (WAN), such as the Internet, whereas the other communications or messages 502, 504, 506, 508, 510, 516, 518, 520, and 530 may be transmitted via short-range wireless transmissions, such as signaling via Bluetooth, Wi-Fi Direct, and/or other similar communication protocols. The client device may transmit a message 500 to the server via WAN that includes a public RSA key, authentication data, and other information that may be stored in a user profile. The point-of-sale device may periodically transmit a non-connectable broadcast message 502 that may include prompts for peripherals (e.g., Bluetooth peripherals) to respond. In response to receiving the non-connectable broadcast message 502, the client device within proximity of the point-of-sale device may broadcast a peripheral response message 504 (i.e., a non-connectable, non-pairing Bluetooth advertisement packet). Based on receiving the peripheral response message 504, the point-of-sale device may initiate a Bluetooth connection 506 with the client device (e.g., send a message to start the connection). The point-of-sale device may transmit a client identifier (or ID) request message 508 over the short-range wireless connection to the client device. In response, the client device may transmit a client identifier (or ID) response 510 via the short-range wireless connection to the point-of-sale device. The point-of-sale device may transmit to the server via the WAN a session start request message 512, and the server may respond by transmitting a session start response message 514 via the WAN that includes at least an encrypted version of a nonce, and optionally an unencrypted version of the nonce as well as user authentication data to authenticate the client device (e.g., photos, voice samples, writing samples, etc.). In some embodiments, the session start response message 514 may only include the encrypted version of the nonce.

Using data from the session start response message 514, the point-of-sale device may transmit to the client device via the short-range wireless connection (e.g., Bluetooth connection) a nonce test request message 516, such as a message that includes the encrypted nonce for the client device to decrypt to verify its identity. The client device may respond by transmitting a nonce test response 518 via the short-range wireless connection to the point-of-sale device, such as a message that includes a decrypted version of the nonce. The point-of-sale device and client device may exchange signals (e.g., messages 520) to end the short-range wireless connection (e.g., Bluetooth connection). The point-of-sale device may transmit to the server via the WAN messages 522 including transaction data that may be used to conduct a transaction, such as charging a financial account associated with the user of the client device. In an optional embodiment, the point-of-sale device may transmit via the WAN to the point-of-sale device an authentication failure message 521 in response to determining the decrypted nonce received via the nonce test response 518 does not match the unencrypted nonce.

In an optional embodiment, the server may transmit via the WAN to the point-of-sale device an additional verification request 524, such as a message indicating that the user of the client device needs to be visually verified (or authenticated) based on a driver's license check by an operator (e.g., a cashier). Such an additional verification may only occur once, such as the first time the user of the client device uses the services of the server and/or the point-of-sale device (e.g., the first time paying for items from a certain retail store, etc.). The point-of-sale device may transmit an optional additional verification response 526 to the server via the WAN, such as a message that indicates the operator (e.g., cashier) has confirmed the user of the client device matches user authenticate data (e.g., a provided driver's license, etc.). The server may conduct a transaction (e.g., a check-out procedure) using the transaction data from the messages 522, and may transmit to the point-of-sale device via the WAN a transaction result 528, such as an indication that the transaction was approved, accepted, failed, rejected, etc. In an optional embodiment, the point-of-sale device may relay that information to the client device as a transaction result relay 530.

FIG. 6 illustrates an embodiment system method 195 that includes individual device methods 600, 350, 800 which may be performed in tandem by a point-of-sale device, a client device, and a server, respectively. The embodiment system methods 190 and 195 may be performed in combination. Alternatively, the embodiment system methods 194 and 195 may be performed in combination. The embodiment method 600 and the embodiment method 800 of the embodiment system method 195 may be performed by a point-of-sale device and a server, respectively, for authenticating a client device based on data decrypted by the client device that is relayed to the server from the point-of-sale device. As described above, as the data decrypted by the client device is encrypted by the server using a predefined public key of a registered user/device, only the actual registered device is capable of decrypting the encrypted data with the appropriate private key. Thus, when unencrypted data stored on the server matches decrypted data received from the client device by the point-of-sale device, the identity of the client device may be considered verified by the server.

The methods 600 and 800 are similar to the methods 250 and 450 described above with reference to FIG. 2B, except that method 800 may include operations for the server to receive decrypted nonces from client device via the point-of-sale device for comparison with unencrypted nonces only stored at the server. Further, method 600 may include operations for the point-of-sale device to transmit transaction data only when it receives from the server confirmed confirmation of the identity of the client device based on the nonce comparisons. The operations of the method 350 for the client device are the same as described above with reference to FIG. 2B. The system method 195 enables a more secure verification of the client device identity, as less sensitive data may be delivered to the point-of-sale device from the server. This may be beneficial when the point-of-sale device could be compromised (e.g., the device is vulnerable to being hacked) and/or the communication link between point-of-sale device and server connection could be compromised (e.g., the link is vulnerable to a “man-in-the-middle” (MITM) attack).

Referring to the method 800 of FIG. 6, in block 802, the server may transmit to the point-of-sale device, via the WAN, the session ID and the encrypted nonce from the user profile associated with the client ID received from the point-of-sale device (see blocks 408-412 described above). In block 602 the processor of the point-of-sale device may receive the session ID and the encrypted nonce from the server. As described above with reference to FIG. 2B, the point-of-sale device may transmit the encrypted nonce to the client device via the short-range wireless connection in block 254, receive a decrypted nonce from the client device in block 256, and initiate the termination of the connection in block 258. As the point-of-sale device never received the unencrypted nonce from the server in FIG. 6, the point-of-sale device may not be capable of determining whether the client device has successfully decrypted the nonce and thus proven its identity. Therefore, in block 604, the processor of the point-of-sale device may transmit a message including the decrypted nonce received from the client device.

In block 804, the server may receive the message including the decrypted nonce from the point-of-sale device. In determination block 806, the server may determine whether the unencrypted nonce stored at the server matches the decrypted nonce received from the point-of-sale device. The operations in determination block 806 may be similar to the operations performed by the point-of-sale device in determination block 260 as described above. For example, as the encrypted nonce was encrypted by the server using a particular public key, only the corresponding private key may be used to decrypt the encrypted nonce to obtain the unencrypted nonce. Therefore, if the decrypted nonce received from the point-of-sale device matches the unencrypted nonce stored at the server, the server may verify or authenticate that the client device is the client device associated with the identifying data and user profile stored at the server.

In response to determining that the unencrypted nonce does not match the decrypted nonce received from the point-of-sale device (i.e., determination block 806=“No”), the server may conclude that the client device is unverified or unauthenticated, and thus, no transaction may occur between the point-of-sale device and the user of the client device. Accordingly, in block 808, the server may transmit a message to the point-of-sale device via the WAN connection indicating that the client device has not been authenticated. The server may return to monitoring for request messages in determination block 408 of method 400 as described above, or monitoring for sighting messages in determination block 492 as described above.

In response to determining that the unencrypted nonce matches the decrypted nonce received from the point-of-sale device (i.e., determination block 806=“Yes”), the client device may be considered verified or authenticated. Accordingly, in block 810, the server may transmit a message to the point-of-sale device indicating that the client device has been authenticated and that a transaction may occur between the point-of-sale device and the user of the client device. The server may receive information from the point-of-sale device and perform operations for conducting a transaction related to the session ID in blocks 456-462 as described above.

Returning to the method 600, in determination block 606, the processor of the point-of-sale device may determine whether the client device has been authenticated based on messages received from the server. The operations in determination block 606 may be similar to the operations performed by the server in optional determination block 454 described above. In other words, the point-of-sale device may monitor for messages that include codes or other information that indicate that the client device has provided the correct decrypted nonce that matches the unencrypted nonce stored on the server, and so its identity has been verified.

In response to determining that the client device has been authenticated by the server (i.e., determination block 606=“Yes”), the processor of the point-of-sale device may process the transaction by performing the operations in blocks 266-269 as described above. In response to determining that the client device is not authenticated by the server (i.e., determination block 606=“No”), the processor of the point-of-sale device may display a failure message (or ID failure message) that indicates that the client device was not authenticated by the server in optional block 608. For example, the point-of-sale device may render a message indicating that the client device and/or its user are not to be trusted for a sales transaction and/or that they should be questioned by a cashier operating the point-of-sale device. The point-of-sale device may revert to periodically broadcasting short-range wireless messages in block 202 (or block 292) as described above.

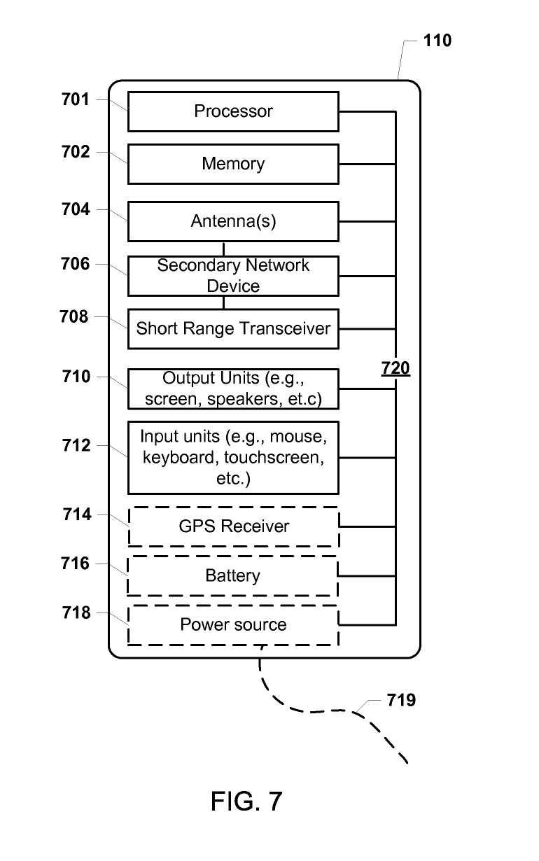

FIG. 7 illustrates components of an exemplary point-of-sale (POS) device 110 suitable for use with various embodiments. The point-of-sale device 110 may include one or more processor 701 that may be coupled to various components 702-718 via a bus 720 or other circuitry. In particular, the processor 701 may be coupled to a memory 702, one or more antennas 704 for receiving/transmitting electromagnetic energy, a secondary network interface or device 706 (e.g., cellular network modem or transceiver, Wi-Fi radio, Ethernet connection, etc.), and a short-range transceiver 708 (e.g., a Bluetooth, Wi-Fi Direct, Peanut, Zigbee, etc.) coupled to the one or more antennas 704. In various embodiments, the point-of-sale device 110 may utilize the short-range transceiver 708 to periodically non-connectable broadcast messages (e.g., advertisement packets) that include various information, such as an identifier (e.g., a MAC address, secure or rolling identifier, etc.), and that may be received and processed by nearby devices, such as mobile devices configured to monitor for short-range wireless signals. In various embodiments, the point-of-sale device 110 may utilize the short-range transceiver 708 to establish persistent connections with nearby devices, such as Bluetooth connections with Bluetooth paired peripheral devices. In various embodiments, the secondary network interface or device 706 may be coupled to the one or more antennas 704 and may be capable of communicating directly or indirectly with a remote server via a wide area network, such as the Internet. In some embodiments, the secondary network interface or device 706 may be or include a cellular or wireless transceiver or a modem or other wired network device. The point-of-sale device 110 may also include various output units 710, such as a display screen (e.g., LED screen, etc.), speakers, lights, and/or haptic feedback units, as well as various input units 712, such as a mouse, a keyboard, and a touch screen.

In some embodiments, the point-of-sale device 110 may include a global positioning system (GPS) receiver 714 or other type of location determining mechanism for determining a current location to associate with any short-range message received from nearby devices. If the point-of-sale device 110 is not mobile, it may not include the GPS receiver 714 in some embodiments since the location may be known and constant. In some embodiments, the point-of-sale device 110 may also include a battery 716 either as the primary power supply or as a backup power supply in the case of point-of-sale device 110 coupled to utility power, and/or may further include a power source 718 configured to be directly connected to an external power source via a connection 719. For example, the connection 719 may be a plug configured to connect to a wall outlet.

Although these components are shown linked by a common connection, they may interconnected and configured in various ways. Since these components may be microchips of standard or off-the-shelf configuration, they are represented in FIG. 7 as blocks consistent with the structure of an example embodiment.

In some embodiments, the point-of-sale device 110 may store software instructions, such as within the memory 702 or other circuitry that may be utilized by the processor 701 to perform operations to transmit and/or receive short-range and long-range signals, respectively. In an embodiment, the point-of-sale device 110 may utilize the one or more antennas 704 to receive update software, instructions, or other data for storage and use in updating firmware, modifying operating parameters, and other configuration modifications.

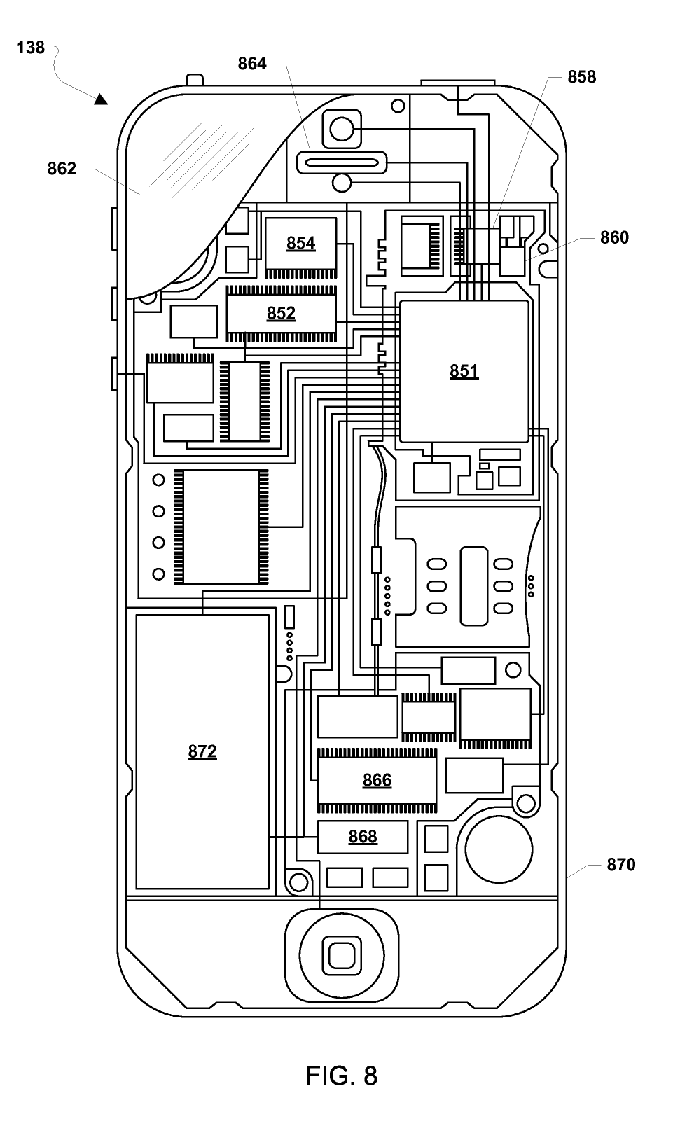

FIG. 8 illustrates an embodiment mobile device 138. In various embodiments, the mobile device 138 may include a processor 851 coupled to a touch screen controller 854 and an internal memory 852. The processor 851 may be one or more multicore integrated circuits (ICs) designated for general or specific processing tasks. The internal memory 852 may be volatile or nonvolatile memory, and may also be secure and/or encrypted memory, or unsecure and/or unencrypted memory, or any combination thereof. The touch screen controller 854 and the processor 851 may also be coupled to a touch screen panel 862, such as a resistive-sensing touch screen, capacitive-sensing touch screen, infrared sensing touch screen, etc. The mobile device 138 may have one or more radio signal transceivers 858 (e.g., Peanut®, Bluetooth®, Zigbee®, Wi-Fi, RF radio, etc.) and antennae 860, for sending and receiving, coupled to each other and/or to the processor 851. The transceivers 858 and antennae 860 may be used with the above-mentioned circuitry to implement the various wireless transmission protocol stacks and interfaces. The mobile device 138 may include various network interfaces or devices, such as a cellular network wireless modem chip 866 that enables communication via a cellular network and is coupled to the processor. The mobile device 138 may include a peripheral device connection interface 868 coupled to the processor 851. The peripheral device connection interface 868 may be singularly configured to accept one type of connection, or multiply configured to accept various types of physical and communication connections, common or proprietary, such as universal serial bus (USB), FireWire, Thunderbolt, or PCIe. The peripheral device connection interface 868 may also be coupled to a similarly configured peripheral device connection port (not shown). The mobile device 138 may also include speakers 864 for providing audio outputs. The mobile device 138 may also include a housing 870, constructed of a plastic, metal, or a combination of materials, for containing all or some of the components discussed herein. The mobile device 138 may include a power source 872 coupled to the processor 851, such as a disposable or rechargeable battery. The rechargeable battery may also be coupled to the peripheral device connection port to receive a charging current from a source external to the mobile device 138.

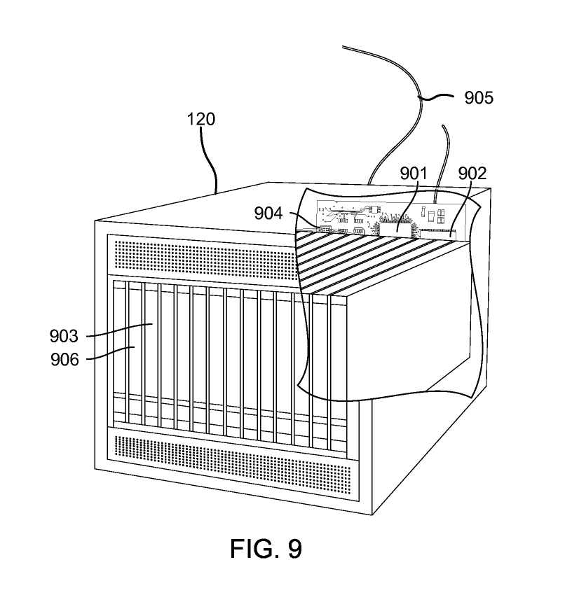

FIG. 9 is a system block diagram of a server 120 suitable for implementing the various embodiments of this disclosure. The server 120 may be a commercially available server device. Such a server 120 typically includes a processor 901 coupled to volatile memory 902 and a large capacity nonvolatile memory, such as a disk drive 903. The server 120 may also include a floppy disc drive, compact disc (CD) or DVD disc drive 906 coupled to the processor 901. The server 120 may also include various network interfaces or devices, such as network access ports 904 coupled to the processor 901 for establishing data connections with a network 905, such as a wide area network or a local area network coupled to other broadcast system computers and servers.

Processors of computing devices as described herein may be any programmable microprocessor, microcomputer or multiple processor chip or chips that can be configured by software instructions (e.g., applications) to perform a variety of functions, including the functions of the various embodiments described below. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module (or processor-executable instructions), which may reside on a non-transitory computer-readable storage medium (or non-transitory processor-readable storage medium). Non-transitory computer-readable storage media may be any available media that may be accessed by a computer. By way of example, and not limitation, such non-transitory computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for a client device to conduct transactions based on proximity to a point-of-sale device without sending secure information via short-range wireless signaling, comprising:
transmitting, by a processor of the client device to a server via a wide area network connection, a first message including a public key of an encryption key pair, wherein the encryption key pair includes a private key stored on the client device;
receiving, by the processor of the client device via short-range wireless signals, a second message broadcast from the point-of-sale device that requests a peripheral response from the client device;
broadcasting, by the processor of the client device via the short-range wireless signals, a third message indicating that the client device is available as a peripheral in response to receiving the second message;
establishing, by the processor of the client device, a short-range wireless connection with the point-of-sale device in response to the point-of-sale device receiving the third message;
transmitting, by the processor of the client device via the established short-range wireless connection, identifying data to the point-of-sale device;
receiving, by the processor of the client device via the established short-range wireless connection, an encrypted nonce from the point-of-sale device;
decrypting, by the processor of the client device, the encrypted nonce using the private key; and
transmitting, by the processor of the client device to the point-of-sale device via the established short-range wireless connection, the decrypted nonce.

2. The method of claim 1, wherein the second message broadcast by the point-of-sale device via the short-range wireless signals includes a secure identifier of the point-of-sale device, the method further comprising:
transmitting, by the processor of the client device to the server via the wide area network connection, a sighting message including the secure identifier of the point-of-sale device in response to receiving the second message; and
receiving, by the processor of the client device from the server via the wide area network connection, a fourth message indicating whether the point-of-sale device can be trusted by the client device,
wherein broadcasting, by the processor of the client device via the short-range wireless signals, the third message indicating that the client device is available as the peripheral in response to receiving the second message comprises broadcasting, by the processor of the client device via the short-range wireless signals, the third message indicating that the client device is available as the peripheral in response to receiving the second message and in response to the fourth message indicating that the point-of-sale device can be trusted.

3. The method of claim 1, wherein the short-range wireless signals and the established short-range wireless connection utilize a Bluetooth communication protocol.

4. The method of claim 1, wherein the wide area network connection utilizes Internet communications.

5. The method of claim 1, wherein the client device is a mobile device and the transactions are associated with a retailer.

6. A method for a point-of-sale device to conduct transactions based on proximity to a client device without sending secure information via short-range wireless signaling, comprising:
broadcasting, by a processor of the point-of-sale device via short-range wireless signals, a first message requesting a peripheral response;
receiving, by the processor of the point-of-sale device via the short-range wireless signals, a second message indicating that the client device is available as a peripheral in response to receiving the first message;
establishing, by the processor of the point-of-sale device, a short-range wireless connection with the client device in response to the point-of-sale device receiving the second message;
receiving, by the processor of the point-of-sale device via the established short-range wireless connection, identifying data of the client device;
transmitting, by the processor of the point-of-sale device to a server via a wide area network connection, a session start request including the received identifying data of the client device;
receiving, by the processor of the point-of-sale device via the wide area network connection from the server, an encrypted nonce generated by the server using an unencrypted nonce and a public key stored in a user profile associated with the received identifying data of the client device in response to transmitting the session start request;
transmitting, by the processor of the point-of-sale device to the client device via the established short-range wireless connection, the encrypted nonce;
receiving, by the processor of the point-of-sale device via the established short-range wireless connection, a decrypted nonce based on the encrypted nonce; and
transmitting, by the processor of the point-of-sale device to the server via the wide area network connection, information for conducting a transaction related to the client device in response to the client device being authenticated based on the received decrypted nonce.

7. The method of claim 6, further comprising:
receiving, by the processor of the point-of-sale device via the wide area network connection from the server, the unencrypted nonce with the encrypted nonce in response to transmitting the session start request; and
determining, by the processor of the point-of-sale device, whether the received decrypted nonce matches the received unencrypted nonce,
wherein transmitting, by the processor of the point-of-sale device to the server via the wide area network connection, the information for conducting the transaction related to the client device in response to the client device being authenticated based on the received decrypted nonce comprises transmitting, by the processor of the point-of-sale device to the server via the wide area network connection, the information for conducting the transaction related to the client device in response to determining the received decrypted nonce matches the received unencrypted nonce.

8. The method of claim 6, further comprising:
transmitting, by the processor of the point-of-sale device via the wide area network connection to the server, a third message including the decrypted nonce; and
receiving, by the processor of the point-of-sale device via the wide area network connection from the server, a fourth message indicating whether the client device is authenticated based on the decrypted nonce,
wherein transmitting, by the processor of the point-of-sale device to the server via the wide area network connection, the information for conducting the transaction related to the client device in response to the client device being authenticated based on the received decrypted nonce comprises transmitting, by the processor of the point-of-sale device to the server via the wide area network connection, the information for conducting the transaction related to the client device in response to the received fourth message indicating the client device is authenticated based on the decrypted nonce matching the unencrypted nonce stored on the server.

9. The method of claim 6, further comprising receiving, by the processor of the point-of-sale device via the wide area network connection from the server, a transaction result indicating whether the transaction was successful.

10. The method of claim 9, further comprising displaying, by the processor of the point-of-sale device, the transaction result received from the server.

11. The method of claim 6, wherein receiving, by the processor of the point-of-sale device via the wide area network connection from the server, the encrypted nonce generated by the server using the unencrypted nonce and the public key stored in the user profile associated with the received identifying data of the client device in response to transmitting the session start request comprises receiving, by the processor of the point-of-sale device from the server via the wide area network connection, the encrypted nonce, the unencrypted nonce, and user authentication data from the stored user profile in response to transmitting the session start request,
the method further comprising:
displaying, by the processor of the point-of-sale device, the received authentication data; and
receiving, by the processor of the point-of-sale device, an input indicating whether a user of the client device is authenticated based on the user authentication data.

12. The method of claim 11, wherein the user authentication data includes an image of the user of the client device.

13. The method of claim 6, wherein the short-range wireless signals and the established short-range wireless connection utilize a Bluetooth communication protocol.

14. The method of claim 6, wherein the wide area network connection utilizes Internet communications.

15. The method of claim 6, further comprising receiving, by the processor of the point-of-sale device from the server via the wide area network connection, an additional authentication request, wherein the additional authentication request requires a driver's license check by an operator of the point-of-sale device.

16. The method of claim 6, wherein the transaction is associated with a retailer, and the point-of-sale device is owned by the retailer.

17. A system, comprising:
a client device;
a point-of-sale device; and
a server,
wherein the client device comprises:
a first short-range wireless transceiver;
a first wide area network interface in communication with a wide area network via a first wide area network connection; and
a first processor configured with processor-executable instructions for performing operations comprising:
transmitting, to the server via the first wide area network interface, a first message including a public key of an encryption key pair, wherein the encryption key pair includes a private key stored on the client device;
receiving, via the first short-range wireless transceiver, a second message broadcast from the point-of-sale device that requests a peripheral response;
broadcasting, via the first short-range wireless transceiver, a third message indicating that the client device is available as a peripheral in response to receiving the second message;
establishing, with the first short-range wireless transceiver, a short-range wireless connection with the point-of-sale device in response to broadcasting the third message;
transmitting, to the point-of-sale device via the short-range wireless connection established with the first short-range wireless transceiver, identifying data of the client device;
receiving, from the point-of-sale device via the short-range wireless connection established with the first short-range wireless transceiver, an encrypted nonce;
decrypting the encrypted nonce using the private key; and
transmitting, to the point-of-sale device via the short-range wireless connection established with the first short-range wireless transceiver, the decrypted nonce,
wherein the point-of-sale device comprises:
a second short-range wireless transceiver;
a second wide area network interface in communication with the wide area network via a second wide area network connection; and
a second processor configured with processor-executable instructions for performing operations comprising:
broadcasting, via the second short-range wireless transceiver, the second message requesting the peripheral response;
receiving, via the second short-range wireless transceiver, the third message indicating that the client device is available as the peripheral in response to broadcasting the second message;
establishing, with the second short-range wireless transceiver, the short-range wireless connection with the client device in response to the point-of-sale device receiving the third message;
receiving, from the client device via the short-range wireless connection established with the second short-range wireless transceiver, the identifying data;
transmitting, to the server via the second wide area network interface, a session start request including the received identifying data of the client device;
receiving, from the server via the second wide area network connection, the encrypted nonce in response to transmitting the session start request;
transmitting, to the client device via the short-range wireless connection established with the second short-range wireless transceiver, the encrypted nonce;
receiving, from the client device via the short-range wireless connection established with the second short-range wireless transceiver, the decrypted nonce; and
transmitting, to the server via the second wide area network interface, information for conducting a transaction related to the client device in response to the client device being authenticated based on the received decrypted nonce, and
wherein the server comprises:
a third wide area network interface in communication with the wide area network via a third wide area network connection; and
a third processor configured with processor-executable instructions for performing operations comprising:
receiving, from the client device via the third wide area network interface, the first message including the public key of the encryption key pair;
storing the received public key in relation to a user profile associated with the client device;
receiving, from the point-of-sale device via the third wide area network interface, the session start request including the received identifying data of the client device;
generating the encrypted nonce by encrypting an unencrypted nonce with the public key stored in the user profile associated with the identifying data of the client device;
transmitting, to the point-of-sale device via the third wide area network connection, the encrypted nonce in response to receiving the session start request; and
receiving, from the point-of-sale device via the third wide area network interface, the information for conducting the transaction related to the client device in response to the client device being authenticated based on the decrypted nonce.

18. The system of claim 17, wherein the second message broadcast by the point-of-sale device via short-range wireless signals includes a secure identifier of the point-of-sale device, and wherein the first processor of the client device is configured with processor-executable instructions for performing operations further comprising:
transmitting, to the server via the first wide area network interface, a sighting message including the secure identifier of the point-of-sale device in response to receiving the second message; and
receiving, from the server via the first wide area network interface, a fourth message indicating whether the point-of-sale device can be trusted by the client device,
wherein the first processor of the client device is configured with processor-executable instructions such that broadcasting, via the first short-range wireless transceiver, the third message indicating that the client device is available as the peripheral in response to receiving the second message comprises broadcasting, via the first short-range wireless transceiver, the third message indicating that the client device is available as the peripheral in response to receiving the second message and the fourth message indicating that the point-of-sale device can be trusted, and
wherein the third processor of the server is configured with processor-executable instructions for performing operations further comprising:
receiving, from the client device via the third wide area network interface, the sighting message including the secure identifier of the point-of-sale device;
processing the secure identifier of the sighting message to determine whether the point-of-sale device can be trusted by the client device; and
transmitting, to the client device via the third wide area network interface, the fourth message indicating whether the point-of-sale device can be trusted by the client device based on the processing.

19. The system of claim 17, wherein the second processor of the point-of-sale device is configured with processor-executable instructions for performing operations further comprising:
receiving, from the server via the second wide area network interface, the unencrypted nonce with the encrypted nonce in response to transmitting the session start request; and
determining whether the received decrypted nonce matches the received unencrypted nonce,
wherein the second processor of the point-of-sale device is configured with processor-executable instructions for performing operations such that transmitting, to the server via the second wide area network interface, the information for conducting the transaction related to the client device in response to the client device being authenticated based on the received decrypted nonce comprises transmitting, to the server via the second wide area network interface, the information for conducting the transaction related to the client device in response to determining the received decrypted nonce matches the received unencrypted nonce, and
wherein the third processor of the server is configured with processor-executable instructions for performing operations further comprising transmitting, to the point-of-sale device via the third wide area network connection, the unencrypted nonce in response to receiving the session start request.

20. The system of claim 17, wherein the second processor of the point-of-sale device is configured with processor-executable instructions for performing operations further comprising:
transmitting, to the server via the second wide area network interface, a fourth message including the decrypted nonce; and
receiving, from the server via the second wide area network interface, a fifth message indicating whether the client device is authenticated based on the decrypted nonce,
wherein transmitting, to the server via the second wide area network interface, the information for conducting the transaction related to the client device in response to the client device being authenticated based on the received decrypted nonce comprises transmitting, to the server via the second wide area network connection, the information for conducting the transaction related to the client device in response to the received fifth message indicating the client device is authenticated based on the decrypted nonce matching the unencrypted nonce stored on the server, and
wherein the third processor of the server is configured with processor-executable instructions for performing operations further comprising:
receiving, from the point-of-sale device via the third wide area network interface, the fourth message including the decrypted nonce;
determining whether the client device is authenticated based on the decrypted nonce matching the unencrypted nonce stored on the server; and
transmitting, to the point-of-sale device via the third wide area network interface, the fifth message indicating the client device is authenticated based on the decrypted nonce in response to determining the decrypted nonce matches the unencrypted nonce stored on the server.
